(19) United States
(12) Patent Application Publication
(10) Pub. No.: US 2021/0210758 A1
(43) Pub. Date: Jul. 8, 2021

(54) COMPOSITE PARTICLES, METHOD FOR PRODUCING COMPOSITE PARTICLES, LITHIUM ION SECONDARY BATTERY ELECTRODE, AND LITHIUM ION SECONDARY BATTERY

(71) Applicant: HONDA MOTOR CO., LTD., Tokyo (JP)

(72) Inventors: Kazuki SAIMEN, Saitama (JP); Takeshi FUJINO, Saitama (JP); Yusuke OKAMOTO, Saitama (JP)

(21) Appl. No.: 17/056,765

(22) PCT Filed: May 13, 2019
(86) PCT No.: PCT/JP2019/018985

§ 371 Date: Nov. 19, 2020

(30) Foreign Application Priority Data
May 24, 2018 (JP) 2018-099451

(51) Int. Cl. H01M 4/583; H01M 10/0525; H01M 4/04; H01M 4/62; H01M 10/0568

(52) U.S. Cl. CPC H01M 4/583; H01M 10/0525; H01M 4/0404; H01M 2004/021; H01M 4/0471; H01M 10/0568; H01M 4/622

(57) ABSTRACT

Provided are composite particles, a method for producing composite particles, a lithium ion secondary battery electrode, and a lithium ion secondary battery, that can realize a lithium ion secondary battery having an excellent durability and having a large capacity due to a reduction in internal resistance. A lithium ion secondary battery comprises: a positive electrode provided with a positive electrode active material layer containing a positive electrode active material and a conduction auxiliary agent; a negative electrode provided with a negative electrode active material layer containing a negative electrode active material and a conduction auxiliary agent. At least one of the positive electrode active material layer and the negative electrode active material layer contains a conduction auxiliary agent-lithium ion conductive inorganic solid electrolyte composite in which at least a portion of the surface of a lithium ion conductive inorganic solid electrolyte is coated by a conduction auxiliary agent.

This application is based on and claims the benefit of priority from Japanese Patent Application No. 2018-099451, filed on 24 May 2018, the content of which is incorporated herein by reference.

### TECHNICAL FIELD

The present invention relates to composite particles, a method for producing composite particles, an electrode for a lithium ion secondary battery, and a lithium ion secondary battery.

### BACKGROUND ART

In recent years, various studies have been conducted toward the practical application of an all-solid-state lithium ion secondary batteries using a lithium ion conductive inorganic solid electrolyte as an electrolyte.

However, all-solid-state lithium ion secondary batteries have improved thermal stability as compared with conventional lithium ion secondary batteries using a nonaqueous electrolyte solution, but have large specific gravity, resulting in increasing the weight.

Consequently, the weight energy density is reduced, and the lithium ion secondary batteries are not advantageous in the basic commercial property.

Then, as a realistic solution technique, use of a lithium ion conductive inorganic solid electrolyte in a lithium ion secondary battery using a nonaqueous electrolyte solution has been considered. For example, in a conventional lithium ion secondary battery using a carbonate electrolyte solution as a nonaqueous electrolyte solution, a technology of covering an active material surface with a lithium ion conductive inorganic solid electrolyte such as a NASICON phosphoric acid compound is known (see, for example, Patent Documents 1 and 2).

According to the lithium ion secondary battery described in Patent Documents 1 and 2, when the surface of the active material is covered with a lithium ion conductive inorganic solid electrolyte, a contact area between the active material and the nonaqueous electrolyte solution is reduced, and as a result, decomposition of the nonaqueous electrolyte solution due to a chemical reaction between the active material and the nonaqueous electrolyte solution can be suppressed, and durability can be improved.
Patent Document 1: Japanese Unexamined Patent Application, Publication No. 2008-117542
Patent Document 2: Japanese Unexamined Patent Application, Publication No. 2009-064732

### DISCLOSURE OF THE INVENTION

### Problems to be Solved by the Invention

However, oxidative decomposition of a nonaqueous electrolyte solution in a positive electrode and reduction decomposition of a nonaqueous electrolyte solution in a negative electrode are both conducted by acceptance and release of electrons, and the reaction field thereof is a surface of a conduction auxiliary agent having the lowest electric resistance.

Therefore, even if the surface of the active material is covered with a lithium ion conductive inorganic solid electrolyte, decomposition of the nonaqueous electrolyte solution cannot sufficiently be suppressed, and durability of the lithium ion secondary battery cannot sufficiently be improved.

Furthermore, since a lithium ion in the nonaqueous electrolyte solution is solvated with a solvent, when the surface of the active material is covered with the lithium ion conductive inorganic solid electrolyte, the lithium ion cannot be conducted inside the lithium ion conductive inorganic solid electrolyte.

Therefore, it is inconvenient that the reaction area on the surface of the active material is reduced, and the internal resistance of the lithium ion secondary battery is increased.

Then, the lithium ion secondary battery cannot achieve sufficient performance in a large current charge and discharge (high rate) when the internal resistance is increased.

The present invention eliminates such inconvenience, and has an object to provide composite particles capable of achieving a lithium ion secondary battery having excellent durability, and large capacity by decrease of the internal resistance, a method for producing the composite particles, an electrode for a lithium ion secondary battery, and a lithium ion secondary battery.

### Means for Solving the Problems

In order to achieve such an object, the present invention provides composite particles being particles to be blended in an electrode of a lithium ion secondary battery including an electrolyte solution, the composite particles including high-dielectric oxide solid particles and an electron conducting material, at least a portion of a surface of the high-dielectric oxide solid particles being covered with the electron conducting material.

In the composite particles of the present invention, since at least a portion of the high-dielectric oxide solid particles is covered with the electron conducting material, when the composite particles are blended in an electrode mixture layer constituting an electrode of a lithium ion secondary battery including an electrolyte solution, a contact area between the electron conducting material and the electrolyte solution is reduced, decomposition of the electrolyte solution due to charge and discharge can be suppressed.

As a result, the obtained lithium ion secondary battery can express excellent durability to the charge and discharge cycle.

In the composite particles of the present invention, the electron conducting material may be supported by and integrated with the surface of the high-dielectric oxide solid particles.

Since in the composite particles of the present invention, the electron conducting material is supported by and integrated with the surface of the high-dielectric oxide solid particles, at least a portion of the interface between the electron conducting material and the high-dielectric oxide solid particles can be made to be continuous, and the internal resistance of the obtained lithium ion secondary battery can further be reduced.

The electron conducting material constituting the composite particles of the present invention may have pores, and store an electrolyte solution in the pores.

When the electron conducting material constituting the composite particles of the present invention has pores, since the electrolyte solution can be stored in the pores, the contact area between the composite particles and the electrolyte solution can be increased. As a result, the internal resistance of the obtained lithium ion secondary battery can further be reduced, and large capacity can be obtained.

In the composite particles of the present invention, the electron conducting material may be a conductive carbon.

The conductive carbon has in itself pores, and easily forms a structural configuration in which particles are connected to each other.

Therefore, retention ability of the electrolyte solution by the composite particles of the present invention can be improved.

Furthermore, when the retention ability of the electrolyte solution is improved, when the composite particles of the present invention are blended in the electrode mixture, an electrolyte solution can be retained in the vicinity of the electrode active material, output can be improved, and liquid leakage by expansion and contraction of the electrode body due to charge and discharge can be suppressed.

Furthermore, the conductive carbon is a substance used as a conduction auxiliary agent in electrode mixture constituting an electrode for a lithium ion secondary battery.

Therefore, in the composite particles of the present invention, when an electron conducting material for covering the high-dielectric oxide solid particle is a conductive carbon, an electrode for a lithium ion secondary battery can be formed of the material similar to the conventional electrode mixture.

In the composite particles of the present invention, the electron conducting material may have an electronic conductivity of 10⁻¹ S/cm or more at 25° C., and a DBP oil absorption amount of 100 ml/100 g or more.

When the electron conducting material constituting the composite particles of the present invention has an electronic conductivity of 10⁻¹ S/cm or more at 25° C., the internal resistance of the obtained lithium ion secondary battery can further be reduced, and increase of overvoltage can be suppressed.

Furthermore, when the electron conducting material has a DBP oil absorption amount of 100 ml/100 g or more, since a large amount of electrolyte solution can be included in the electron conducting material, the interface between the high-dielectric oxide solid particle and the electrolyte solution can be increased, and as a result, the internal resistance of a lithium ion can be reduced.

The high-dielectric oxide solid particle constituting the composite particles of the present invention may be an oxide solid having a relative dielectric constant of powder at 25° C. of 10 or more.

Use of the oxide solid having a relative dielectric constant of powder at 25° C. of 10 or more as the high-dielectric oxide solid particle constituting the composite particles of the present invention can improve the degree of dissociation of the electrolyte solution and reduce the resistance of the electrolyte solution.

In the composite particles of the present invention, the high-dielectric oxide solid particle may be an oxide solid having a lithium ion conductivity at 25° C. of 10⁻⁷ S/cm or more.

When the high-dielectric oxide solid particle constituting the composite particles of the present invention has ion conductivity at 25° C. of 10⁻⁷ S/cm or more, the high-dielectric oxide solid particle has a easily polarizable property, and therefore can adsorb a counter anion in the electrolyte solution, a lithium ion conductivity inhibitor such as an organic solvent to enhance the degree of dissociation and transport number of lithium ions.

As a result, the internal resistance of the obtained lithium ion secondary battery can further be reduced, so that large capacity can be obtained.

When the composite particles of the present invention are blended in the positive electrode, the high-dielectric oxide solid particles may not be dissolved in the electrolyte solution, and may not show pH 12 or more at the time of impregnation of the aqueous solution.

When the composite particles of the present invention are blended in the positive electrode mixture, constituting high-dielectric oxide solid particles are not dissolved in the electrolyte solution and do not show pH 12 or more at the time of impregnation of the aqueous solution, corrosion of a current collector foil at the time of production of electrode does not proceed, so that increase in the internal resistance of the obtained lithium ion secondary battery can be suppressed.

When the composite particles of the present invention are blended in the negative electrode, the high-dielectric oxide solid particles are not dissolved in the electrolyte solution, and are not reductively decomposed at 1 V or more with respect to Li/Li⁺ electrode.

When the composite particles of the present invention are blended in the negative electrode mixture, if the constituting high-dielectric oxide solid particles are not dissolved in the electrolyte solution and not reductively decomposed at 1 V or more with respect to a Li/Li⁺ electrode, high-dielectric oxide solid particle itself is not decomposed at the time of charging during durability measurement, and therefore can be allowed to be present in the negative electrode stably.

As a result, also after durability measurement, an effect of suppressing the internal resistance of the lithium ion secondary battery can be maintained.

In the composite particles of the present invention, the coverage of the electron conducting material on a surface of the high-dielectric oxide solid particles may be 15 or more.

When in the composite particles of the present invention, the coverage of the electron conducting material on the surface of the high-dielectric oxide solid particles is 15% or more, the internal resistance of the obtained lithium ion secondary battery can further be reduced.

In the composite particles of the present invention, a mass ratio of the electron conducting material to the high-dielectric oxide solid particle may be 0.5:99.5 to 80:20.

In the composite particles of the present invention, when the mass ratio of the electron conducting material to the high-dielectric oxide solid particle is in a range of 0.5:99.5 to 80:20, both an effect of improving the electronic conductivity and an effect of suppressing decomposition of the electrolyte solution can be achieved. Specifically, when the mass ratio of the electron conducting material is less than 0.5, a function of improving the electronic conductivity is not expressed, and the state is not different from that of the untreated high dielectric oxide solid particles.

Furthermore, even when the mass ratio of the electron conducting material is more than 80, since a mass of the conduction auxiliary agent contributing integration is not increased more, any more effect cannot be obtained.

Another of the present invention is a method for producing the above-mentioned composite particles of the present invention, the method including an integrating step of attaching or bonding the electron conducting material to a surface of the high-dielectric oxide solid particle by a mechanical technique or a chemical technique.

According to the method for producing composite particles of the present invention, the electron conducting material can be integrated on the surface of the high-dielectric oxide solid particle by a mechanical technique or a chemical technique.

Still another of the present invention is an electrode for a lithium ion secondary battery including an electrolyte solution, including a layer made of an electrode mixture including an electrode active material, and the composite particles of the present invention.

The electrode for a lithium ion secondary battery of the present invention includes the above-mentioned composite particles of the present invention in an electrode mixture layer including a positive electrode active material or a negative electrode active material.

The electrode for a lithium ion secondary battery including an electrode mixture layer including the composite particles of the present invention has the composite particles of the present invention in the vicinity of the electrode active material.

As a result, it is possible to achieve a lithium ion secondary battery allowing the effect of suppressing a decomposition reaction of an electrolyte solution on a surface of the electrode active material, and the effect of promoting insertion and elimination of lithium ions to function simultaneously, and having excellent durability with respect to a charge and discharge cycle.

In the electrode for a lithium ion secondary battery of the present invention, a blending amount of the composite particles may be 0.1 parts by mass or more and 5 parts by mass or less with respect to a total of the electrode mixture.

In the electrode for a lithium ion secondary battery of the present invention, when the blending amount of the composite particles is 0.1 parts by mass or more and 5 parts by mass or less with respect to the total amount of the electrode mixture, the effect of suppressing a decomposition of a reaction electrolyte solution on the surface of electrode active material and the effect of promoting insertion and elimination of lithium ions can be allowed to function simultaneously.

Furthermore, when the blending amount is less than 0.1 parts by mass, a ferroelectric effect and a degree of dissociation of infiltrating an electrolyte solution into the inside of the electrode are insufficient. On the other hand, when the blending amount is more than 5 parts by mass, the amount of the electrolyte solution infiltrating into the inside of the electrode is insufficient. Consequently, a contact interface between the active material and the electrolyte solution cannot be sufficiently obtained, so that a movement route of lithium ions inside the electrode is limited.

In the electrode for a lithium ion secondary battery of the present invention, the composite particles may have an average particle diameter of 1/10 or less of an average particle diameter of the electrode active materials, and the high-dielectric oxide solid particles have an average particle diameter of 5 times or more as large as a thickness of the electron conducting material.

Furthermore, in the electrode for a lithium ion secondary battery of the present invention, the composite particles may have an average particle diameter of 1/10 or less of an average particle diameter of the electrode active material, and the high-dielectric oxide solid particles may have an average particle diameter of 5 times or more as large as a thickness of the electron conducting material.

In the electrode for lithium ion secondary battery of the present invention, when the composite particles have an average particle diameter of 1/10 or less of an average particle diameter of the electrode active material, the composite particles can be surely arranged in gaps in the electrode active material.

Furthermore, when the high-dielectric oxide solid particles have an average particle diameter of 5 times or more as large as an average particle diameter of primary particles or a thickness of the high-dielectric oxide solid, a sufficiently large interface can be formed between the high-dielectric oxide solid particles and the electron conducting material.

In the electrode for a lithium ion secondary battery of the present invention, a mass ratio of the electrode active materials to the composite particles may be 99:1 to 80:20.

In the electrode for a lithium ion secondary battery of the present invention, when a mass ratio of the electrode active materials to the composite particles is in a range of 99:1 to 80:20, sufficient electronic conductivity can be secured. As a result, a lithium ion secondary battery having a large energy density can be achieved.

The electrode for a lithium ion secondary battery of the present invention may be a positive electrode.

The electrode for a lithium ion secondary battery of the present invention may be a negative electrode.

Yet another of the present invention is a lithium ion secondary battery including a positive electrode, a negative electrode, and an electrolyte solution, at least one of the positive electrode and the negative electrode being the electrode for a lithium ion secondary battery of the present invention.

In the lithium ion secondary battery of the present invention, at least one of the positive electrode and the negative electrode is the electrode for a lithium ion secondary battery of the present invention, thereby obtaining a lithium ion secondary battery having excellent durability and a large capacity by reducing internal resistance.

### BRIEF DESCRIPTION OF THE DRAWINGS

FIG. 1 is a graph showing charge capacity of a lithium ion secondary battery of the present invention;

FIG. 2 is a graph showing discharge capacity of the lithium ion secondary battery of the present invention;

FIG. 3 is a graph showing a capacity retention rate with respect to a charge and discharge cycle of the lithium ion secondary battery of the present invention; and

FIG. 4 is a graph showing reaction resistance and diffusion resistance of the lithium ion secondary battery of the present invention.

### PREFERRED MODE FOR CARRYING OUT THE INVENTION

Hereinafter, embodiments of the present invention will be described in more detail.

Note here that the present invention is not limited to the following embodiments.

<Composite Particles>

The composite particles of the present invention are particles to be blended in an electrode of a lithium ion secondary battery including an electrolyte solution, the composite particles including high-dielectric oxide solid particles and an electron conducting material, at least a portion of a surface of the high-dielectric oxide solid particles being covered with the electron conducting material.

In the composite particles of the present invention, since at least a portion of the high-dielectric oxide solid particles is covered with an electron conducting material, when the composite particles are blended in an electrode mixture layer constituting the electrode of the lithium ion secondary battery including an electrolyte solution, a contact area between the electron conducting material and the electrolyte solution is reduced, and decomposition of the electrolyte solution due to charge and discharge can be suppressed. As a result, the obtained lithium ion secondary battery can express excellent durability with respect to the charge and discharge cycle.

In the composite particles of the present invention, it is preferable that the electron conducting material is supported by and integrated with the surface of the high-dielectric oxide solid particles.

Since in the composite particles of the present invention, the electron conducting material is supported by and integrated with the surface of the high-dielectric oxide solid particles, at least a portion of the interface between the electron conducting material and the high-dielectric oxide solid particles can be made to be continuous, and the internal resistance of the obtained lithium ion secondary battery can further be reduced.

[Coverage]

In the composite particles of the present invention, the coverage of the electron conducting material on a surface of the high-dielectric oxide solid particle is preferably 15% or more.

The coverage is further preferably 20% or more, and particularly preferably 25% or more.

In the composite particles of the present invention, when the coverage of the electron conducting material on the surface of the high-dielectric oxide solid particle is 15% or more, the internal resistance of the obtained lithium ion secondary battery can further be reduced.

[Mass Ratio of Electron Conducting Material to High-Dielectric Oxide Solid Particles]

In the composite particles of the present invention, a mass ratio of an electron conducting material to high-dielectric oxide solid particles when they are composed is preferably 0.5:99.5 to 80:20.

The mass ratio is further preferably in a range of 0.5:99.5 to 67:33, and particularly preferably in a range of 0.5:99.5 to 20:80.

In the composite particles of the present invention, when the mass ratio of the electron conducting material to the dielectric oxide solid particles is in a range of 0.5:99.5 to 80:20, both an effect of improving the electronic conductivity and an effect of suppressing decomposition of an electrolyte solution can be achieved.

Specifically, when the mass ratio of the electron conducting material is less than 0.5, a function of improving the electronic conductivity is not expressed, and the state is not different from that of the untreated high dielectric oxide solid particles.

Furthermore, even when the mass ratio of the electron conducting material is more than 80, since a mass of a conduction auxiliary agent contributing to integration is not increased more, any more effect cannot be obtained.

[High-Dielectric Oxide Solid Particle]

The high-dielectric oxide solid particle constituting the composite particles of the present invention is not particularly limited, and examples thereof include compounds having excellent Li-ion conductivity, such as a composite oxide having an ilmenite structure of LiₓNb_{y}O₃, and LiₓTa_{y}O₃ (x/y=0.9 to 1.1), a composite oxide having a garnet structure represented by Li₇₋ₓLa₃₋ₓAₓZr_{2-y}M_{y}O₁₂ (A is one metal selected from the group consisting of Y, Nd, Sm, and Gd, 0<x<3 is satisfied, M is one metal selected from the group consisting of Nb, Ta, Sb, Bi, and Pb, and 0<y<2 is satisfied), LISICON-type lithium ion conducting composite oxide such as Li₁₋₆Al_{0.6}Ti_{1.4}(PO₄)₃ (LATP), Li_{1.5}Al_{0.5}Ge_{1.5}(PO₄)₃ (LAGP), and Li_{1+x+y}(Al, Ga)ₓ(Ti, Ge)₂₋ₓSi_{y}P₃₋yO₁₂ (0≤x≤1, 0≤y≤1), and the like.

Furthermore, the examples include a dielectric compound of the composite metal oxide having a perovskite crystalline structure, such as BaTiO₃, BaₓSr₁₋ₓTiO₃ (x=0.4 to 0.8), BaZrₓTi₁₋ₓO₃ (x=0.2 to 0.5), or KNbO₃, SrBi₂Ta₂O₉.

The high-dielectric oxide solid particle may be used alone or in combination of two or more types.

Among them, the high-dielectric oxide solid particle constituting the composite particles of the present invention is preferably an oxide solid having a relative dielectric constant of powder at 25° C. of 10 or more.

The oxide solid has preferably relative dielectric constant of powder of 15 or more, and particularly preferably 20 or more.

When the high-dielectric oxide solid particle constituting the composite particles of the present invention is an oxide solid having a relative dielectric constant of powder at 25° C. of 10 or more, the degree of dissociation of an electrolyte solution can be improved, and the resistance of the electrolyte solution can be reduced.

Herein, the “relative dielectric constant of powder” in the present description refers to a value obtained as follows.

### [Measurement Method of Relative Dielectric Constant of Powder]

A powder body is introduced into a tablet molder for measurement having a diameter (R) of 386 m, and compressed to a thickness (d) of 1 to 2 mm using a hydraulic press machine so as to form a pressed powder body.

The condition for molding the pressed powder body is that the relative density of powder body (D_{powder})=the pressurized powder body weight density/the true specific gravity of dielectric substance×100 is 40% or more. For this molded product, electrostatic capacity Cₜₒₜₐₗ at 25° C. and at 1 kHz is measured by an automatic equilibrium bridge method using an LCR meter, and the relative dielectric constant εₜₒₜₐₗ of the pressurized powder body is calculated.

For obtaining the dielectric constant of the real volume ε_{power} from the obtained pressurized powder body relative dielectric constant, the “relative dielectric constant of powder ε_{powder}” is calculated using the following formulae (1) to (3) where the vacuum dielectric constant ε₀ is 8.854×10⁻¹², and the relative dielectric constant of the air εₐᵢᵣ is 1.

Contact area A of pressed powder body and electrode=(R/2)²*π (1)

Cₜₒₜₐₗ=εₜₒₜₐₗ×ε₀×(A/d) (2)

εₜₒₜₐₗ=ε_{powder}×D_{powder}+εₐᵢᵣ×(1−D_{powder}) (3)

Examples of the ferroelectric oxide having relative dielectric constant of powder of 10 or more include, but not particularly limited to, BaTiO₃, KNbO₃, SrBi₂Ta₂O₉, and the like.

Furthermore, in the composite particles of the present invention, the high-dielectric oxide solid particle is preferably an oxide solid having lithium ion conductivity at 25° C. of 10⁻⁷ S/cm or more.

When the high-dielectric oxide solid particle constituting the composite particles has lithium ion conductivity at 25° C. of 10⁻⁷ S/cm or more, the high-dielectric oxide solid particle has an easily polarizability, and therefore can adsorb a counter anion in the electrolyte solution, a lithium ion conduction inhibitor such as an organic solvent to enhance the transport number of lithium ions. As a result, the internal resistance of the obtained lithium ion secondary battery can further be reduced, so that large capacity can be obtained.

Furthermore, when the composite particles of the present invention are used for the positive electrode, it is preferable that the high-dielectric oxide solid particles constituting the composite particles are not dissolved in the electrolyte solution and do not show pH 12 or more at the time of impregnation of an aqueous solution. At the time of the impregnation of an aqueous solution, pH is more preferably in a range of 7 to 12, and particularly preferably in a range of 7 to 11.

When the composite particles of the present invention are blended in the positive electrode mixture, when the high-dielectric oxide solid particles constituting the composite particles are not dissolved in the electrolyte solution, and do not show pH 12 or more at the time of impregnation of the aqueous solution, corrosion of a current collector foil does not proceed at the time of producing the electrode, so that the increase in the internal resistance of the obtained lithium ion battery can be suppressed.

Examples of the high-dielectric oxide solid particles that are not dissolved in an electrolyte solution and do not show pH 12 or more at the time of impregnation of the aqueous solution include, but not particularly limited to, Li₃PO₄, LiNbO₃, composite metal oxide containing a NASICON type crystalline structure represented by the chemical formula: Li_{1+x+y}(Al, Ga)ₓ(Ti, Ge)₂₋ₓSi_{y}P_{3-y}O₁₂ (wherein 0≤x≤1, 0≤y≤1), composite metal oxide having a perovskite crystalline structure, such as, BaₓSr₁₋ₓTiO₃ (x=0.4 to 0.8), BaZrₓTi₁₋ₓO₃ (x=0.2 to 0.5), KNbO₃, SrBi₂Ta₂O₉, or the like.

Furthermore, when the composite particles of the present invention are used for the negative electrode, it is preferable that the high-dielectric oxide solid particles constituting the composite particles are not dissolved in the electrolyte solution and are not reductively decomposed in the Li/Li⁺ electrode at 1 V or more.

The high-dielectric oxide solid particles are not reductively decomposed in the Li/Li⁺ electrode more preferably at 0.5 V or more, and particularly preferably at 0 V or more.

When the composite particles of the present invention are blended in a negative electrode mixture, when the constituting high-dielectric oxide solid particles are not dissolved in the electrolyte solution and not reductively decomposed to the Li/Li⁺ electrode at 1 V or more, since the high-dielectric oxide solid particles themselves are not decomposed at the time of charging during durability measurement, the composite particles can be stably allowed to be present in the negative electrode.

As a result, even after durability measurement, an effect of suppressing the internal resistance of the lithium ion secondary battery can be maintained.

Examples of the high-dielectric oxide solid particles that are not dissolved in the electrolyte solution and are not reductively decomposed in the Li/Li⁺ electrode at 1 V or more include, but not particularly limited to, Li₃PO₄, composite metal oxide having a garnet structure represented by the chemical formula: L_{7-y}La₃₋ₓAₓZr_{2-y}M_{y}O₁₂ (in the formula, A represents one metal selected from the group consisting of Y, Nd, Sm, and Gd, x is in a range of 0≤x<3, M is Nb or Ta, and y is in a range of 0≤y<2), BaₓSr₁₋ₓTiO₃ (x=0.4 to 0.8), BaZrₓTi₁₋ₓO₃ (x=0.2 to 0.5), or composite metal oxides having a perovskite crystalline structure, such as KNbO₃, and SrBi₂Ta₂O₃, and the like.

[Electron Conducting Material]

The electron conducting material constituting composite particles of the present invention is not particularly limited, and examples thereof include carbon black such as Ketjen black and acetylene black, graphite, fibrous carbon, metal such as aluminum and copper, tungsten oxide, and the like.

Among them, it is preferable that electron conducting material constituting the composite particles of the present invention has pores, and can store an electrolyte solution in the pores.

When the electron conducting material constituting the composite particles of the present invention has pores, since the electrolyte solution can be stored in the pores, the contact area between the composite particles and the electrolyte solution can be increased. As a result, the internal resistance of the obtained lithium ion secondary battery can further be reduced, and large capacity can be obtained.

Furthermore, it is preferable that the electron conducting material constituting the composite particles of the present invention is a conductive carbon.

The conductive carbon has in itself pores, and easily forms a structural configuration in which particles are connected to each other.

Therefore, retention ability of the electrolyte solution by the composite particles of the present invention can be improved.

Furthermore, when the retention ability of the electrolyte solution is improved, when the composite particles of the present invention are blended in the electrode mixture, an electrolyte solution can be retained in the vicinity of the electrode active material, output can be improved, and liquid leakage by expansion and contraction of the electrode body due to charge and discharge can be suppressed.

Furthermore, the conductive carbon is a substance to be used as a conduction auxiliary agent in electrode mixture constituting an electrode for a lithium ion secondary battery.

Therefore, in the composite particles of the present invention, when an electron conducting material for covering the high-dielectric oxide solid particle is a conductive carbon, an electrode for a lithium ion secondary battery can be formed of the material similar to the conventional electrode mixture.

Furthermore, it is preferable that the electron conducting material constituting the composite particles of the present invention has an electronic conductivity of 10⁻¹ S/cm or more at 25° C., and a DBP oil absorption amount of 100 ml/100 g or more.

The electron conducting material has more preferably an electronic conductivity of 10⁰ S/cm or more at 25° C., and a DBP oil absorption amount of 120 ml/100 g or more, and particularly preferably an electronic conductivity of 10¹ S/cm or more, and a DBP oil absorption amount of 150 ml/100 g or more.

When the electron conducting material constituting the composite particles of the present invention has an electronic conductivity of 10⁻¹ S/cm or more at 25° C., the internal resistance of the obtained lithium ion secondary battery can further be reduced, and increase of overvoltage can be suppressed.

Furthermore, when the electron conducting material has a DBP oil absorption amount of 100 ml/100 g or more, a large amount of the electrolyte solution can be included in the electron conducting material. Therefore, an interface between the high-dielectric oxide solid particles and the electrolyte solution can be increased. As a result, the internal resistance of the lithium ion can be reduced.

<Method for Producing Composite Particles>

The method for producing composite particles of the present invention includes an integration step of attaching or bonding the above-mentioned electron conducting material on a surface of the above-mentioned high-dielectric oxide solid particle by a mechanical technique or a chemical technique.

According to the method for producing composite particles of the present invention, the electron conducting material can be integrated on a surface of the high-dielectric oxide solid particle by a mechanical technique or a chemical technique.

The mechanical technique is not particularly limited, and examples thereof include a method of attaching or bonding an electron conducting material to the surface of high-dielectric oxide solid particles by mechanical milling.

Alternatively, processing may be carried out by a method selected from the group consisting of mechano-fusion, planetary mixing, and kneading.

Furthermore, the chemical technique is not particularly limited, and examples thereof include a chemical vapor deposition method (CVD method), a physical vapor growth method, and the like.

The chemical vapor deposition method is not particularly limited, and examples thereof include a method of thermally decomposing gas (air) of aliphatic saturated hydrocarbon as a carbon source to be carbonized, and a method of coating high-dielectric oxide solid particles with carbon, and the like.

The aliphatic saturated hydrocarbon gas as a carbon source is not particularly limited, and examples thereof include propane, butane, 2-methyl propane, and the like.

The thermal decomposition temperature of aliphatic saturated hydrocarbon is desirably 600° C. to 850° C.

The temperature is more desirably 600° C. to 800° C., and particularly desirably 650° C. to 800° C.

When the temperature is less than 600° C., crystallization of thermally decomposed carbon does not proceed, and sufficient electronic conductivity cannot be obtained.

On the other hand, the temperature is more than 850° C., reduction decomposition of the high-dielectric oxide solid particles or sintering of particles proceeds, and the aimed composite particles cannot be obtained.

Devices to be used for the chemical vapor deposition method are not particularly limited, and, for example, a reaction device capable of calcining in a state in which a gas atmosphere can be controlled in a reduced atmosphere can be used.

Examples of the devices include a quartz tube kiln furnace, a rotary kiln furnace, and the like.

<Electrode for Lithium Ion Secondary Battery>

The electrode for a lithium ion secondary battery of the present invention is an electrode for a lithium ion secondary battery including an electrolyte solution, including a layer made of an electrode mixture including an electrode active material, the above-mentioned composite particles of the present invention.

In other words, in the electrode for a lithium ion secondary battery of the present invention, an electrode mixture layer including the positive electrode active material or the negative electrode active material includes the above-mentioned composite particles of the present invention.

The electrode for a lithium ion secondary battery of the present invention has the composite particles of the present invention in the vicinity of the electrode active material.

As a result, it is possible to achieve a lithium ion secondary battery allowing the effect of suppressing a decomposition reaction of an electrolyte solution on a surface of the electrode active material, and the effect of promoting insertion and elimination of lithium ions to function simultaneously, and having excellent durability with respect to a charge and discharge cycle.

Note here that the electrode for a lithium ion secondary battery of the present invention may be a positive electrode or a negative electrode.

The layer made of an electrode mixture including the above-mentioned composite particles of the present invention is provided, and thereby the above-mentioned effects can be expressed in both electrodes.

[Blending Amount of Composite Particles]

In the electrode for a lithium ion secondary battery of the present invention, a blending amount of the composite particles is preferably 0.1 parts by mass or more and 5 parts by mass or less with respect to the total amount of the electrode mixture.

The blending amount is more preferably 0.5 parts by mass or more and 5.0 parts by mass or less, and particularly preferably 0.5 parts by mass or more and 2.0 parts by mass or less.

In the electrode for a lithium ion secondary battery of the present invention, when the blending amount of the composite particles is 0.1 parts by mass or more and 5 parts by mass or less with respect to the total amount of the electrode mixture, an effect of suppressing a decomposition of a reaction electrolyte solution on the surface of electrode active material and an effect of promoting insertion and elimination of lithium ions can be allowed to function simultaneously. Furthermore, when the blending amount is less than 0.1 parts by mass, a ferroelectric effect and a degree of dissociation of infiltrating an electrolyte solution into the inside of the electrode are insufficient. On the other hand, when the blending amount is more than 5 parts by mass, the amount of the electrolyte solution infiltrating into the inside of the electrode is insufficient. Consequently, a contact interface between the active material and the electrolyte solution cannot be sufficiently obtained, so that a movement route of lithium ions inside the electrode is limited.

[Relation of Average Particle Diameter of High-Dielectric Oxide Solid Particles, Electron Conducting Material, and Electrode Active Material]

In the electrode for a lithium ion secondary battery of the present invention, the average particle diameter of the composite particles and the average particle diameter of the high-dielectric oxide solid particles are 1/10 or less of the average particle diameter of the electrode active material, the average particle diameter of the high-dielectric oxide solid particles is preferably 5 times or more as large as the average particle diameter of the primary particles of the electron conducting material.

Furthermore, in the electrode for a lithium ion secondary battery of the present invention, it is preferable that the average particle diameter of the composite particles is 1/10 or less of the average particle diameter of the electrode active materials, and the average particle diameter of the high-dielectric oxide solid particles is 5 times or more as large as a thickness of the electron conducting material.

In the electrode for a lithium ion secondary battery of the present invention, it is further preferable that the average particle diameter of the composite particles is 1/10 or less of the average particle diameter of the electrode active materials, and the average particle diameter of the high-dielectric oxide solid particles is 15 times or more as large as the average particle diameter or a thickness of the electron conducting material.

In the electrode for lithium ion secondary battery of the present invention, when the composite particles have an average particle diameter of 1/10 or less of an average particle diameter of the electrode active material, the composite particles can be surely arranged in gaps in the electrode active material.

Furthermore, when the high-dielectric oxide solid particles have an average particle diameter of 5 times or more as large as an average particle diameter of primary particles or a thickness of the high-dielectric oxide solid, a sufficiently large interface can be formed between the high-dielectric oxide solid particles and the electron conducting material.

[Mass Ratio of Electrode Active Materials to Composite Particles]

In the electrode for a lithium ion secondary battery of the present invention, the mass ratio of electrode active materials to composite particles is preferably 99.5:0.5 to 80:20.

The mass ratio of the electrode active materials to the composite particles is more preferably 99.5:0.5 to 90:10, and particularly preferably 99.5:0.5 to 95:5.

When the electrode for a lithium ion secondary battery of the present invention has a mass ratio of the electrode active materials to the composite particles of 99.5:0.5 to 80:20, sufficient electronic conductivity can be secured. As a result, a lithium ion secondary battery having a large energy density can be achieved.

[Configuration of Electrode]

A configuration of the electrode for a lithium ion secondary battery of the present invention is not particularly limited, and examples thereof can include a configuration in which a layer made of an electrode mixture including an electrode active material and composite particles of the present invention mentioned above are stacked on the current collector.

The electrode mixture of the electrode for a lithium ion secondary battery of the present invention is not particularly limited as long as the electrode active material and the composite particles of the present invention are included, but may include other components, for example, a conduction auxiliary agent and a binding agent.

[Positive Current Collector]

As the positive current collector, for example, an aluminum current collector including aluminum, and the like, can be used.

[Positive Electrode Active Material]

As the positive electrode active material, for example, an oxide capable of occluding and releasing lithium, such as, olivine type, layered type, spinel type, and polyanion type lithium transition metal compounds can be used.

Examples of the olivine type lithium transition metal compound include manganese lithium phosphate (LiFePO₄), lithium iron phosphate (LiFePO₄), lithium cobalt phosphate (LiCoPO₄), and the like.

Furthermore, examples of the layered lithium transition metal compound include lithium cobaltate (LiCoO₂), lithium nickelate (LiNiO₂), manganese dioxide (III)lithium (LiMnO₂), ternary system oxide represented by LiNiₓCo_{y}Mn_{z}O₂ (0≤x≤1, 0≤x≤1, 0≤x≤1, x+y+z=1), and the like.

Furthermore, examples of the spinel type lithium transition metal compound can include lithium manganate (LiMn₂O₄), and the like. Examples of the polyanion-type lithium transition metal compound can include lithium vanadium phosphate (Li₃V₂(PO₄)₃), and the like.

[Conduction Auxiliary Agent for Positive Electrode]

Examples of a conduction auxiliary agent to be used for a positive electrode can include carbon black such as Ketjen black and acetylene black, graphite, fibrous carbon, and the like.

[Binding Agent for Positive Electrode]

Examples of a binding agent (binder) to be used for a positive electrode can include polyvinylidene fluoride (PVDF).

[Negative Electrode Current Collector]

Examples of a negative electrode current collector can include a copper current collector made of a copper foil and the like.

[Negative Electrode Active Material]

Examples of a negative electrode active material can include lithium transition metal oxide such as lithium titanate (Li₄Ti₅O₁₂), an alloy such as TiSi and La₃Ni₂Sn₇, carbon materials such as hard carbon, soft carbon, and graphite, metallic single substance such as lithium, indium, aluminum, tin, and silicon, or alloys of these metals, and the like.

[Conduction Auxiliary Agent/Binding Agent for Negative Electrode]

A conduction auxiliary agent to be used for a negative electrode is the same as the conduction auxiliary agent to be used for the positive electrode. Examples of the binding agent (binder) to be used for the negative electrode include a mixture of carboxymethyl cellulose (CMC) and styrene-butadiene rubber (SBR).

<Lithium Ion Secondary Battery>

A lithium ion secondary battery of the present invention includes a positive electrode, a negative electrode, and an electrolyte solution, wherein at least one of the positive electrode and the negative electrode is the electrode for a lithium ion secondary battery of the present invention.

Note here that in the present invention, both the positive electrode and the negative electrode may be the electrode for a lithium ion secondary battery of the present invention.

In the lithium ion secondary battery of the present invention, at least one of the positive electrode and the negative electrode is the electrode for a lithium ion secondary battery of the present invention, thereby obtaining a lithium ion secondary battery having excellent durability and a large capacity by reducing internal resistance.

[Configuration of Lithium Ion Secondary Battery]

A configuration of the lithium ion secondary battery of the present invention is not particularly limited as long as the lithium ion secondary battery includes a positive electrode, a negative electrode, and an electrolyte solution, and may include other components.

Examples of the configuration include a configuration including a positive electrode, a negative electrode, an electrolyte solution, and a separator for electrically insulating the positive electrode and the negative electrode from each other.

[Separator]

As the separator, it is preferable to use a separator exhibiting low resistance to ion movement of an electrolyte solution and also being excellent in retention of the electrolyte solution.

Examples of such a separator include nonwoven fabric or woven fabric made of at least one material selected from the group consisting of glass, polyester, polytetrafluoroethylene, polyethylene, polyamide, aramid, polypropylene, and fluororubber coated cellulose.

[Electrolyte Solution]

As an electrolyte solution, it is possible to use an electrolyte solution obtained by dissolving an electrolyte salt in a non-aqueous solvent.

Examples of the nonaqueous solvent include cyclic carbonic esters, chain carbonic esters, esters, cyclic ethers, chain ethers, nitriles, amides, and combinations thereof.

Examples of the cyclic carbonic ester include ethylene carbonate, vinylene carbonate, propylene carbonate, butylene carbonate, and the like.

Furthermore, the cyclic carbonic ester may be a compound in which some or all of the hydrogen groups of the compound such as trifluoropropylene carbonate or fluoroethyl carbonate are fluorinated.

Examples of the chain carbonic ester include dimethyl carbonate, ethyl methyl carbonate, diethyl carbonate, methylpropyl carbonate, ethylpropyl carbonate, methylisopropyl carbonate, and the like, and may include compounds in which a part of all of the hydrogen group of these compounds are fluoridated.

Examples of the esters include methyl acetate, ethyl acetate, propyl acetate, methyl propionate, ethyl propionate, and γ-butyrolactone, and the like.

Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, crown ether, and the like.

Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-butoxyethane, diethylene glycol dimethyl ether, diethylene glycol diethyl ether, diethylene glycol butyl ether, 1,1-dimethoxymethane, 1,1-diethoxyethane, triethylene glycol dimethyl ether, tetraethylene glycol dimethyl ether, and the like.

Examples of the nitriles can include acetonitrile and the like, and examples of the amides can include dimethylformamide and the like.

Among the above, from the viewpoint of voltage stability, it is preferable to use one or more of cyclic carbonate esters such as ethylene carbonate and propylene carbonate, and chain carbonate esters such as dimethyl carbonate, diethyl carbonate, and dipropyl carbonate, in combination.

Examples of the electrolyte salt include LiPF₆, LiAsF₆, LiBF₄, LiCF₃SO₃, LiN(ClF₂ₗ₊₁SO₂)(CₘF₂ₘ₊₁SO₂) (l and m are a positive integer), LiC(CₚF₂ₚ₊₁SO₂)(C_{q}F_{2q+1}SO₂)(CrF₂ᵣ₊₁SO₂) (p, q, and r are a positive integer), lithium difluoro(oxalato)borate, and the like, and one or two or more of these can be used in combination.

### EXAMPLES

Hereinafter, the present invention is described in detail with reference to Examples.

However, the present invention is not limited to the following Examples.

### Example 1

### [Production of Composite Particles]

In this Example, firstly, carbon black as an electron conducting material, and Li_{1.3}Al_{0.3}Ti_{1.7}P₃O₁₂ (LATP) as a high-dielectric oxide solid particle were mixed with each other at a mass ratio of carbon black LATP=2:1.

The carbon black has a DBP oil absorption amount of 160 ml/100 g, and a primary particle diameter of 35 nm.

Furthermore, LATP has a median diameter (D50) of 0.5 μm, and bulk lithium ion conductivity of 5×10⁻⁴ S/cm.

Note here that the DBP oil absorption amount was measured using dibutylphthalate (DBP) according to the method specified in JIS K 6217-4 (2008).

Next, a mixture of carbon black and LATP and zirconia balls having a diameter of 2 mm were placed in a milling pot, and kneaded for 1 hour at a rotation speed of 1000 rpm using a planetary ball mill apparatus manufactured by Fritsch to obtain composite particles.

The obtained composite particles were observed under an electron microscope, coverage of a surface of LATP with carbon black was 34%.

[Production of Positive Electrode]

LiNi_{0.6}Co_{0.2}Mn_{0.2}O₂ (hereinafter, abbreviated as NCM622) as a positive electrode active material, the composite particles obtained above, and polyvinylidene fluoride (PVDF) as a binding agent (binder) were mixed with each other such that NCM622:carbon black:LATP:PVDF=91:4:2:3 (mass ratio) was satisfied, and the obtained product was mixed with N-methyl-2-pyrrolidone (NMP) as a dispersion solvent to produce positive electrode paste.

NCM622 has a median diameter of 12.4 μm.

Next, the obtained positive electrode paste was applied to a positive electrode current collector made of aluminum, dried, pressurized by roll press, and then dried at 120° C. in vacuum to form a positive electrode plate having a positive electrode mixture layer.

The obtained positive electrode plate was punched into a size of 30 mm×40 mm to obtain a positive electrode.

[Production of Negative Electrode]

Natural graphite (G) as a negative electrode active material, carbon black as an electron conducting material, a carboxymethyl cellulose (CMC) aqueous solution as a binding agent (binder), and styrene-butadiene rubber (SBR) were mixed with each other such that NG:carbon black:SBRF:CMC=96.5:1:1.5:1 (mass ratio) was satisfied, and the obtained product was mixed with water as a dispersion solvent to prepare a negative electrode paste.

The natural graphite has a median diameter of 12.0 μm.

Furthermore, the carbon black is the same as that used for the composite particles.

Next, the obtained negative electrode paste was applied to a negative electrode current collector made of copper, dried, pressurized by roll press, and then dried at 100° C. in vacuum to form a negative electrode plate having a negative electrode mixture layer.

The obtained negative electrode plate was punched into a size of 34 ml×44 mm to obtain a negative electrode.

[Production of Lithium Ion Secondary Battery]

The laminated body including the above-produced positive electrode and negative electrode with a separator sandwiched therebetween was introduced into a container processed in a bag-shape by heat-sealing an aluminum laminate for secondary battery (manufactured by Dai Nippon Printing Co., Ltd.), an electrolyte solution was injected into the interface of each electrode, and then the container was vacuum-sealed to produce a lithium ion secondary battery.

As the separator, polyethylene microporous film having one surface coated with about 5 μm of alumina particles was used. Furthermore, as the electrolyte solution, a solution obtained by dissolving 1.2 mol/L of LiPF₆ as an electrolyte salt in a mixed solvent of ethylene carbonate, diethyl carbonate, and ethyl methyl carbonate at a volume ratio of 20:40:40 was used.

<Evaluation>

The obtained lithium ion secondary batteries were subjected to the following evaluation.

[Initial Charge Capacity and Initial Discharge Capacity]

Lithium ion secondary battery was charged at a constant current at 0.33 C to 4.2 V, then charged at a constant voltage of 4.2 V for one hour, and the initial charge capacity was measured.

After measurement of the initial charge capacity, the lithium ion secondary battery was left for 30 minutes, and discharged at 0.2 C to 2.5 V. The initial discharge capacity with respect to 0.33 C of electric current was measured.

Next, the initial charge capacity and the initial discharge capacity with respect to the electric current of 1 C and the initial charge capacity and the initial discharge capacity with respect to electric current of 3 C were measured in the same manner as in the case of 0.33 C except that the constant current charging was carried out at 1 C and 3 C.

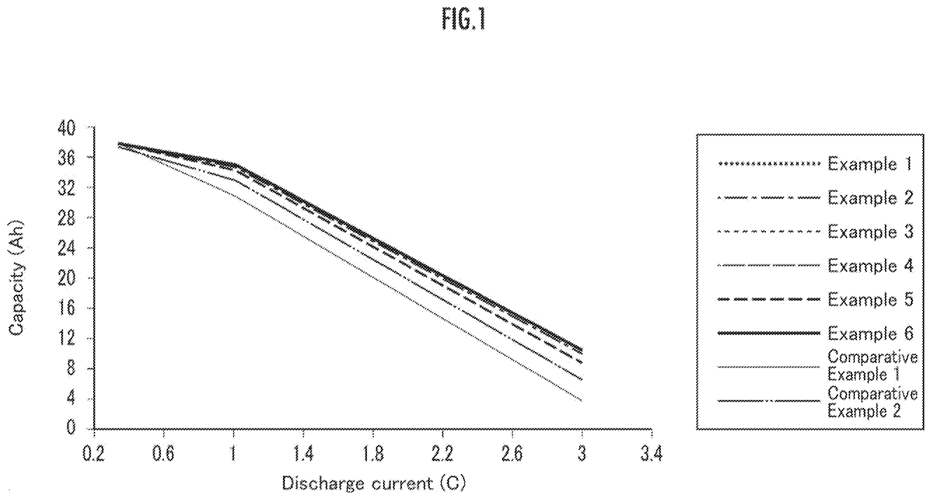

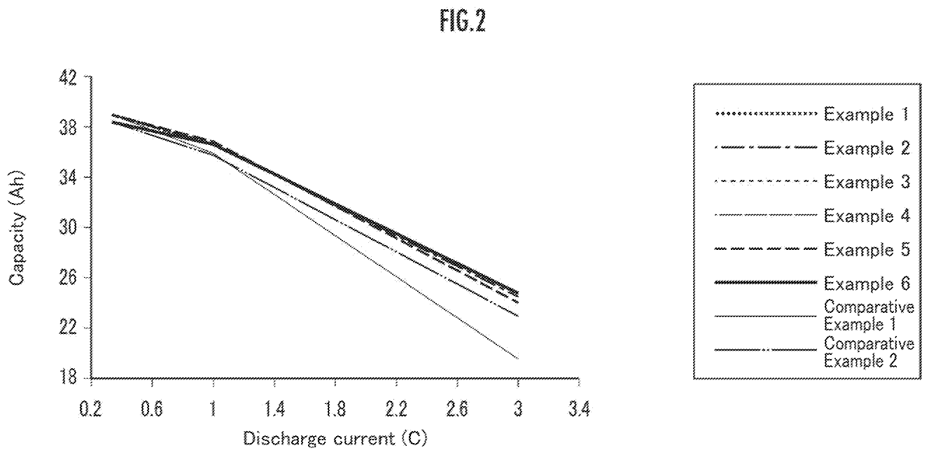

The initial charge capacity is shown in FIG. 1, and the initial discharge capacity is shown in FIG. 2, respectively.

[Discharge Capacity after Durability Test]

As a charge and discharge cycle durability test, an operation of carrying out constant current charging at 1 C to 4.2 V in a constant temperature bath at 45° C. and subsequently carrying out constant current discharging at 2 C to 2.5 V is defined as one cycle. The operation was repeated 1000 cycles.

After completion of 1000 cycles, the discharge capacity after durability test was measured in the same manner as the measurement of the initial discharge capacity mentioned above.

[Discharge Capacity Retention Rate]

The rate of the discharge capacity after 1000 cycles of durability test to the initial discharge capacity was determined to be the discharge capacity retention rate.

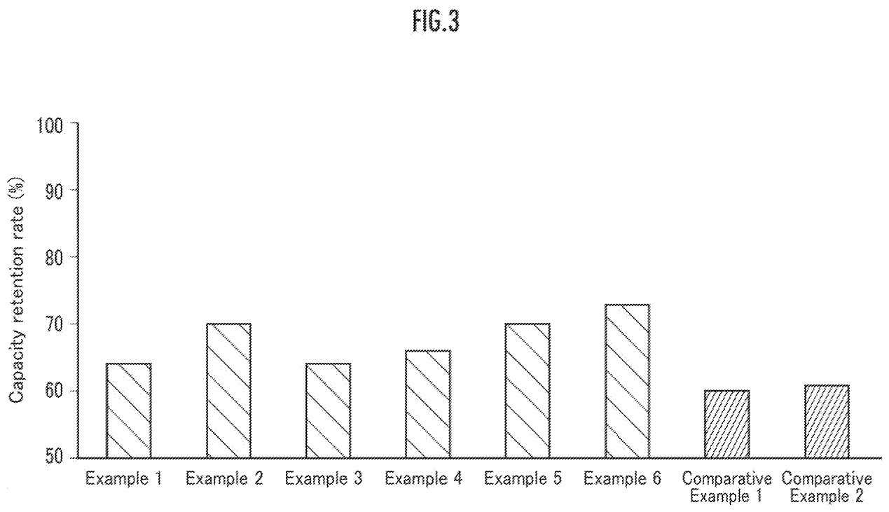

The results are shown in FIG. 3.

[Reaction Resistance/Diffusion Resistance]

Two positive electrodes are arranged facing each other at both ends of the container made of the aluminum laminate for the secondary battery, and a third electrode made of lithium metal is arranged between the two positive electrodes so as to be orthogonal to a line connecting the two positive electrodes, and thus two triode cells were produced. As the electrolyte solution, the same electrolyte solution as that used in the lithium ion secondary battery produced above was used.

Next, one cycle of charging and discharging was performed between one positive electrode and the third electrode and between the other positive electrode and the third electrode, respectively.

Thereafter, the triode cell was disassembled in the glove box to remove the third electrode, thereby producing a positive-positive symmetric cell in which two positive electrodes were arranged facing each other.

In each of the performed charging and discharging in one cycle, a constant current was charged to 4.2 V at 0.01 C, followed by a constant current discharge to 3.2 V.

One cell was then charged at a constant current at 0.02 C to 3.8 V, and then charged at a constant voltage of 3.8 V for one hour.

Next, the symmetric cell was subjected to AC impedance measurement (ACR) at 10⁶ to 10⁻¹, and analyzed based on a cylindrical pore model and a transmission line model to obtain a reaction resistance and a diffusion resistance.

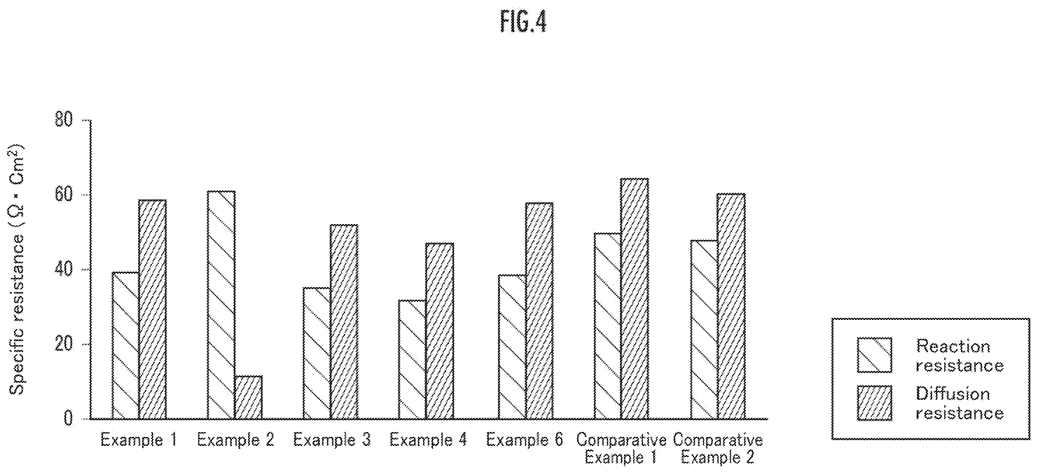

The results are shown in FIG. 4.

### Example 2

Composite particles were produced in the same manner as in Example 1 except that carbon black as an electron conducting material, and LATP as high-dielectric oxide solid particles were mixed with each other at a mass ratio of carbon black:LATP=1:1.

When the obtained composite particles were observed under an electron microscope, the coverage of a surface of ATP with carbon black was 30%.

Next, a lithium ion secondary battery and a symmetric cell were produced in the same manner as in Example 1 except that the composite particles produced in this Example were used, and evaluated in the same manner as in Example 1.

The initial charge capacity is shown in FIG. 1, the initial discharge capacity is shown in FIG. 2, the discharge capacity retention rate is shown in FIG. 3, and the reaction resistance and the diffusion resistance are shown in FIG. 4, respectively.

### Example 3

Composite particles were produced in the same manner as in Example 1 except that carbon black as an electron conducting material and LATP as high-dielectric oxide solid particles were mixed with each other at a mass ratio of carbon black:LATP=4:1.

When the obtained composite particles were observed under an electron microscope, the coverage of a surface of LATP with carbon black was 49%.

Next, a lithium ion secondary battery and a symmetric cell were produced in the same manner as in Example 1 except that the composite particles produced in this Example were used, and evaluated in the same manner as in Example 1.

The initial charge capacity is shown in FIG. 1, the initial discharge capacity is shown in FIG. 2, the discharge capacity retention rate is shown in FIG. 3, and the reaction resistance and the diffusion resistance are shown in FIG. 4, respectively.

### Example 4

Composite particles were produced in the same manner as in Example 1 except that carbon black having a DBP oil absorption amount of 220 ml/100 g and a primary particle diameter of 23 nm as an electron conducting material, and LATP as high-dielectric oxide solid particles were mixed with each other at a mass ratio of carbon black:LATP=2:1.

The obtained composite particles were observed under an electron microscope, coverage of a surface of LATP with carbon black was 34%.

Next, a lithium ion secondary battery and a symmetric cell were produced in the same manner as in Example 1 except that the composite particles produced in this Example were used, and evaluated in the same manner as in Example 1.

The initial charge capacity is shown in FIG. 1, the initial discharge capacity is shown in FIG. 2, the discharge capacity retention rate is shown in FIG. 3, and the reaction resistance and the diffusion resistance are shown in FIG. 4, respectively.

### Example 5

### [Production of Composite Particles]

Composite particles were produced in the same manner as in Example 1 except that Li₇La₃Zr₂O₁₂ (LLZO) having a median diameter of 0.7 m, and bulk lithium ion conductivity of 5×10⁻⁴ S/cm was used as the high-dielectric oxide solid particles.

When the obtained composite particles were observed under an electron microscope, the coverage of a surface of LATP with carbon black was 39%.

[Production of Positive Electrode]

NCM622 as a positive electrode active material, carbon black as an electron conducting material, and polyvinylidene fluoride (PVDF) as a binding agent (binder) were mixed with each other such that carbon black:PVDF=91:4:3 (mass ratio) was satisfied, and the obtained product was mixed with N-methyl-2-pyrrolidone (NMP) as a dispersion solvent to produce positive electrode paste.

NCM622 has a median diameter of 12.4 μm, and the carbon black is the same as that used for the composite particles.

Next, the obtained positive electrode paste was applied to a positive electrode current collector made of aluminum, dried, pressurized by roll press, and then dried at 120° C. in vacuum to form a positive electrode plate having a positive electrode mixture layer.

The obtained positive electrode plate was punched into a size of 30 mm×40 mm to obtain a positive electrode.

[Production of Negative Electrode]

Natural graphite (NG) as a negative electrode active material, composite particles obtained above, a carboxymethyl cellulose (CMC) aqueous solution as a binding agent (binder), and styrene-butadiene rubber (SBR) were mixed with each other such that NG:carbon black:LLZO:SBR:CMC=96.5:1:0.5:1.5:1 (mass ratio) was satisfied, and the obtained product was mixed with water as a dispersion solvent to prepare a negative electrode paste.

The natural graphite has a median diameter of 12.0 μm.

Next, the obtained negative electrode paste was applied to a negative electrode current collector made of copper, dried, pressurized by roll press, and then dried at 100° C. in vacuum to form a negative electrode plate having a negative electrode mixture layer.

The obtained negative electrode plate was punched into a size of 34 mm×44 mm to obtain a negative electrode.

[Production of Lithium Ion Secondary Battery]

A lithium ion secondary battery was produced in the same manner as in Example 1 except that the positive electrode and the negative electrode obtained in this Example were used, and the initial charge capacity, the initial discharge capacity, and the discharge capacity retention rate were measured.

The initial charge capacity is shown in FIG. 1, the initial discharge capacity is shown in FIG. 2, and the discharge capacity retention rate is shown in FIG. 3, respectively.

### Example 6

A positive electrode was formed in the same manner as in Example 1, and then, a negative electrode was formed in the same manner as in Example 5.

In other words, in this Example, the positive electrode includes composite particles including LATP as high-dielectric oxide solid particles, and the negative electrode includes composite particles including LLZO as high-dielectric oxide solid particles.

Next, a lithium ion secondary battery and a symmetric cell were produced in the same manner as in Example 1 except that the positive electrode and the negative electrode obtained in this Example were used, and evaluated in the same manner as in Example 1.

The initial charge capacity is shown in FIG. 1, the initial discharge capacity is shown in FIG. 2, the discharge capacity retention rate is shown in FIG. 3, and the reaction resistance and the diffusion resistance are shown in FIG. 4, respectively.

### Comparative Example 1

A positive electrode was formed in the same manner as in Example 5, and then, a negative electrode was formed in the same manner as in Example 1.

In other words, in this Comparative Example, both the positive electrode and the negative electrode include neither composite particles nor high-dielectric oxide solid particle at all.

Next, a lithium ion secondary battery and a symmetric cell were produced in the same manner as in Example 1 except that the positive electrode and the negative electrode obtained in this Comparative Example were used, and evaluated in the same manner as in Example 1.

The initial charge capacity is shown in FIG. 1, the initial discharge capacity is shown in FIG. 2, the discharge capacity retention rate is shown in FIG. 3, and the reaction resistance and the diffusion resistance are shown in FIG. 4, respectively.

### Comparative Example 2

### [Production of Positive Electrode]

NCM622 as a positive electrode active material, carbon black as an electron conducting material, LATP as high-dielectric oxide solid particles, and polyvinylidene fluoride (PVDF) as a binding agent (binder) were mixed with each other such that carbon black:LATP:PVDF=91:4:2:3 (mass ratio) was satisfied, and the obtained product was mixed with N-methyl-2-pyrrolidone (NMP) as a dispersion solvent to produce positive electrode paste.

NCM622, the carbon black, and LATP are the same as those used in Example 1.

In the positive electrode paste produced in this Comparative Example, the carbon black and LATP are simply mixed with each other, and composite particles are not formed.

Next, a lithium ion secondary battery and a symmetric cell were produced in the same manner as in Example 1 except that the positive electrode paste produced in this Comparative Example was used, and evaluated in the same manner as in Example 1.

The initial charge capacity is shown in FIG. 1, the initial discharge capacity is shown in FIG. 2, the discharge capacity retention rate is shown in FIG. 3, and the reaction resistance and the diffusion resistance are shown in FIG. 4, respectively.

[Consideration]

From FIGS. 1 and 2, it is clear that larger initial charge capacity and initial discharge capacity can be obtained in the lithium ion secondary batteries of Examples 1 to 6 than in the lithium ion secondary batteries of Comparative Examples 1 to 2.

This is thought to be because the composite particles included in a layer of the positive electrode mixture or a layer of the negative electrode mixture improves the transport characteristics of lithium ions, and can mitigate rapid decrease or rapid increase of the concentration of lithium ions in the electrolyte solution present in the positive electrode or the negative electrode.

Furthermore, from FIG. 3, it is clear that a larger discharge capacity retention rate can be obtained in the lithium ion secondary batteries of Examples 1 to 6 than in the lithium ion secondary batteries of Comparative Examples 1 to 2.

This is thought to be because composite particles included in a layer of a positive electrode mixture or a layer of a negative electrode mixture reduces a contact area between the electrolyte solution and the electron conducting material, and suppresses decomposition of the electrolyte solution.

Furthermore, from FIG. 4, it is clear that the lithium ion secondary batteries of Examples 1 to 4 and 6 have smaller sum of the reaction resistance and the diffusion resistance than the lithium ion secondary batteries of Comparative Examples 1 to 2, and can reduce the internal resistance.

### Example 7

### [Production of Composite Particles]

Carbon black (CB) being the same as in Example 1 as the electron conducting material, and Li_{1.3}Al_{0.3}Ti_{1.7}P₃O₁₂ (LATP) as high-dielectric oxide solid particles were mixed with each other at a mass ratio of CB:LATP=1:2.

CB has a DBP oil absorption amount of 160 ml/100 g, and a primary particle diameter of 35 nm.

Furthermore, LATP has a median diameter (D50) of 0.5 μm, and bulk lithium ion conductivity of 5×10⁻⁴ S/cm.

Note here that the DBP oil absorption amount was measured using dibutylphthalate (DBP) according to the method specified in JIS K 6217-4 (2008).

Physical properties of LATP used, and the like, are shown in Table 1.

Next, a mixture of carbon black and LATP, and zirconia balls having was placed in beads mill apparatus using ϕ3 mm zirconia ball. Milling was carried out for one hour at a milling peripheral speed of 5.0 m/s to obtain composite particles.

The obtained composite particles were observed under an electron microscope, coverage of a surface of LATP with carbon black was 25%.

[Production of Positive Electrode]

The obtained composite particles, CB as the electron conducting material, and polyvinylidene fluoride (PVDF) as a binding agent (binder) were preliminarily mixed in a N-methyl-2-pyrrolidone (NMP) as a dispersion solvent, and wet-mixed in a rotation-revolution mixer to obtain a preliminarily mixed slurry.

Subsequently, NCM622 as the positive electrode active material and the obtained preliminarily mixed slurry were mixed with each other, and subjected to dispersion treatment using a planetary mixer to obtain a positive electrode paste.

The mass ratio of each component in the positive electrode paste was set to be NCM622:CB:LATP:PVDF=93.1:4.1:1.0:1.8.

NCM622 has a median diameter of 12 μm.

Next, the obtained positive electrode paste was applied to a positive electrode current collector made of aluminum, dried, pressurized by roll press, and then dried at 120° C. in vacuum to form a positive electrode plate having a positive electrode mixture layer.

The obtained positive electrode plate was punched into a size of 30 mm×40 mm to obtain a positive electrode.

[Production of Negative Electrode]

A carboxymethyl cellulose (CMC) aqueous solution as a binding agent (binder) and carbon black (CB) as an electron conducting material were preliminarily mixed using a planetary mixer.

Subsequently, natural graphite (NG) as a negative electrode active material was mixed therein, and further preliminarily mixed using a planetary mixer.

Thereafter, water as a dispersion solvent and styrene-butadiene rubber (SBR) as a binding agent (binder) were added thereto, and the obtained product was subjected to dispersion treatment using a planetary mixer to obtain a negative electrode paste.

The mass ratio of each component in the negative electrode paste was set to be NG:CB:SBR:CMC=96.5:1.0:1.5:1.0.

The natural graphite has a median diameter of 12 μm.

Furthermore, carbon black (CB) is the same as that used for the composite particles.

Next, the obtained negative electrode paste was applied to a negative electrode current collector made of copper, dried, pressurized by roll press, and then dried at 100° C. in vacuum to form a negative electrode plate having a negative electrode mixture layer.

The obtained negative electrode plate was punched into a size of 34 mm×44 mm to obtain a negative electrode.

[Production of Lithium Ion Secondary Battery]

A laminated body including the positive electrode and the negative electrode with the separator sandwiched therebetween produced above was introduced into a container processed in a bag-shape by heat-sealing an aluminum laminate for secondary battery (manufactured by Dai Nippon Printing Co., Ltd.), an electrolyte solution was injected into the interface of each electrode, and then the container was sealed by reducing a pressure to −95 kPa to produce a lithium ion secondary battery.

As the separator, polyethylene microporous film having one surface coated with about 5 μm of alumina particles was used. Furthermore, as the electrolyte solution, a solution obtained by dissolving 1.2 mol/L of LiPF₆ as an electrolyte salt in a mixed solvent of ethylene carbonate, ethyl methyl carbonate, and dimethyl carbonate at a volume ratio of 30:30:40 was used.

<Evaluation>

The lithium ion secondary battery obtained in Example 7 was subjected to the following evaluation.

[Initial Discharge Capacity]

The produced lithium ion secondary battery was left at measurement temperature (25° C.) for one hour, charged at a constant current of 8.4 mA to 4.2 V, subsequently charged at a constant voltage of 4.2 V for one hour, left for 30 minutes, and then discharged at a constant current of 8.4 mA to 2.5 V.

The above operation was repeated five times, and the discharge capacity at fifth discharging was defined as an initial discharge capacity.

The results are shown in Table 2.

Note here that for the obtained discharge capacity, an electric current value in which discharging is completed for one hour is defined as 1 C.

[Initial Cell Resistance]

A lithium ion secondary battery after measurement of the initial discharge capacity was left at measurement temperature (25° C.) for one hour, then charged at 0.2 C, and left for 10 minutes with a charge level (SOC (State of Charge)) to 50%.

Next, pulse discharging was carried out for 10 seconds with the C rate set at 0.5 C, and a voltage during discharging for 10 seconds was measured.

Then, the voltage during discharging for 10 seconds with respect to the electric current at 0.5 C was plotted with the current value on the abscissa and the voltage on the ordinate.

Next, after lithium ion secondary battery was left for 10 minutes, subjected to auxiliary charging to return SOC to 50%, and then left for 10 minutes.

The above-mentioned operation was carried out for each C rate of 1.0 C, 1.5 C, 2.0 C, 2.5 C, and 3.0 C, and a voltage was plotted during discharging for 10 seconds with respect to an electric current value in each C rate.

Then, the gradient of the approximate straight line by the least-squares method obtained from each plot: was defined as the internal resistance of the lithium ion secondary battery obtained in this Example.

The results are shown in Table 2.

[Discharge Capacity after Durability Test]

As a charge and discharge cycle durability test, an operation of carrying out constant current charging at charging rate of 1 C to 4.2 V in a constant temperature bath at 45° C., and then carrying out constant current discharging at discharging rate of 2 C to 2.5 V is defined as one cycle. The above-mentioned operation was repeated 500 cycles.

After completion of 500 cycles, the constant temperature bath was changed to 25° C. This state was left for 24 hours. Then constant current charging was carried out at 0.2 C to 4.2 V, subsequently, constant voltage charging was carried out at a voltage of 4.2 V for one hour, followed by leaving 30 minutes. Then, constant current discharging was carried out at a discharging rate of 0.2 C to 2.5 V. The discharge capacity after the durability test was measured.

The results are shown in Table 2.

[Cell Resistance after Durability Test]

A lithium ion secondary battery after measurement of discharge capacity after a durability test was charged to be (SOC (State of Charge)) 50% similar to the measurement of the initial cell resistance, and the cell resistance after the durability test was obtained by the same method as in the measurement of the initial cell resistance.

The results are shown in Tables 1 and 2.

[Capacity Retention Rate]

Discharge capacity after the durability test with respect to the initial discharge capacity was determined to obtain a capacity retention rate.

The results are shown in Table 2.

[Cell Resistance Increasing Rate]

The cell resistance after the durability test with respect to the initial cell resistance was determined, and the determined rate was defined as a cell resistance increasing rate.

The results are shown in Table 2.

TABLE 1

| | | | Relative | | Solubility | |
|---|---|---|---|---|---|---|
| | | Li-ion | dielectric constant | | of electrolyte | Median |
| Inorganic particle | Abbreviation | conductivity | of powder | pH | solution | diameter |
| Li [symbol] Al [symbol] Ti [symbol] P [symbol] O [symbol] | LATP | 5.0 × 10 [symbol] S/cm | [symbol] | 7 | Insoluble | 0. [symbol] μm |
| Li [symbol] | LLZO | 5.0 × 10 [symbol] S/cm | 48.7 | 12 | Insoluble | 0.7 μm |
| Li [symbol] PO [symbol] | LPO | 1.0 × 10 [symbol] S/cm | 48.3 | 7 | Insoluble | 0.8 μm |
| LiNbO [symbol] | LNO | 8.0 × 10 [symbol] S/cm | 201 | 9 | Insoluble | 0.5 μm |
| BaTiO [symbol] | BTO | Not having | 87.1 | 7 | Insoluble | 0. [symbol] μm |
| [symbol] | KNO | Not having | [symbol] | 7 | Insoluble | 0. [symbol] μm |
| S [symbol] Bi [symbol] | [symbol] | Not having | 20 | 7 | Insoluble | 0. [symbol] μm |
| Al₂O₃ | AlO | Not having | 8.7 | 7 | Insoluble | 0.7 μm |

[symbol]

indicates data missing or illegible when filed

TABLE 2

| | Example 7 | Example 8 | Example 9 | Example 10 | Example 11 |
|---|---|---|---|---|---|
| Electrode to which composite particles are blended | Positive | Positive | Positive | Positive | Positive |
| | electrode | electrode | electrode | electrode | electrode |
| High-dielectric oxide solid particle | LATP | LATP | LPO | LNO | LATP |
| Electron conducting material constituting | CB | CB | CB | CB | Carbon |
| composite particles | | | | | |
| Electron conducting material:high-dielectric | 1:2 | 1:6 | 1:6 | 1:6 | 0.5:99.5 |
| oxide solid particle (mass ratio) | | | | | |
| Integrating step | Mechanical | Mechanical | Mechanical | Mechanical | Chemical |
| Composition of composite particles in | 1.0 | 1.0 | 1.0 | 1.0 | 1.0 |
| electrode mixture (% by mass) | | | | | |
| Initial discharge capacity (mAh) | 43.2 | 43.2 | 43.0 | 42.5 | 43.0 |
| Discharge capacity after durability test (mAh) | 38.2 | 38.5 | 38.3 | 37.9 | 38.4 |
| Capacity retention rate (%) | 88.5 | 89.1 | 89.1 | 89.3 | 89.4 |
| Initial cell resistance (Ω) | 0.962 | 0.950 | 0.950 | 0.948 | 0.945 |
| Cell resistance after durability test (Ω) | 1.29 | 1.18 | 1.18 | 1.17 | 1.17 |
| Cell resistance increasing rate (%) | 125.0 | 124.2 | 124.2 | 124.0 | 123.8 |

### Example 8

Composite particles were produced in the same manner as in Example 7 except that CB as an electron conducting material and LATP as high-dielectric oxide solid particles were mixed with each other at a mass ratio of CB:LATP=1:6.

When the obtained composite particles were observed under an electron microscope, the coverage of a surface of LATP with CB was 17%.

Next, a lithium ion secondary battery was produced in the same manner as in Example 7 except that the composite particles produced in this Example were used, and evaluated in the same manner as in Example 7.

The results are shown in Table 2.

### Example 9

Composite particles were produced in the same manner as in Example 7 except that LPO shown in Table 1 was used as the high-dielectric oxide solid particle, and CB as an electron conducting material and LPO as high-dielectric oxide solid particles were mixed with each other at a mass ratio of CB:LPO=1:6.

When the obtained composite particles were observed under an electron microscope, the coverage of a surface of LPO with CB was 151.

Next, a lithium ion secondary battery was produced in the same manner as in Example 7 except that the composite particles produced in this Example were used, and evaluated in the same manner as in Example

The results are shown in Table 2.

### Example 10

Composite particles were produced in the same manner as in Example 7 except that LNO shown in Table 1 was used as the high-dielectric oxide solid particle, and CB as an electron conducting material and LNO as high-dielectric oxide solid particles were mixed with each other at a mass ratio of CB:LNO=1:6.

When the obtained composite particles were observed under an electron microscope, the coverage of a surface of LNO with CB was 28%.

Next, a lithium ion secondary battery was produced in the same manner as in Example 7 except that the composite particles produced in this Example were used, and evaluated in the same manner as in Example 7.

The results are shown in Table 2.

### Example 11

### [Production of Composite Particles]

LATP (median diameter (D50): 0.5 μm) as shown in Table 1 as the high-dielectric oxide solid particle, in an amount of 20 g, was inserted into a quartz tube kiln furnace capable of controlling a gas atmosphere. While the quartz tube kiln furnace was rotated at 2 rpm, propane gas was allowed to flow at 300 ml/min, and calcination was carried out at 800° C. for 20 minutes, thereby carbonizing propane gas by thermal decomposition, and coating a surface of LATP with the produced carbon to obtain composite particles.

When the obtained composite particles were observed under an electron microscope, the coverage of the surface of LATP with carbon was 100%. Furthermore, a thickness of the carbon covering the surface of LATP was 1.4 nm.

Next, a lithium ion secondary battery was produced in the same manner as in Example 7 except that the composite particles produced in this Example were used, and evaluated in the same manner as in Example 7.

The results are shown in Table 2.

### Example 12

[Production of Composite Particles]

Composite particles were produced in the same manner as in Example 11 except that incineration was carried out at 800° C. for 120 minutes. When the obtained composite particles were observed under an electron microscope, the coverage of a surface of LATP with carbon was 100%. Furthermore, a thickness of the carbon covering the surface of LATP was 13 nm.

Note here that in Examples 11 and 12 using a chemical technique, a coverage amount with carbon can be controlled by preparing calcination time.

Next, a lithium ion secondary battery was produced in the same manner as in Example 7 except that the composite particles produced in this Example were used, and evaluated in the same manner as in Example 7.

The results are shown in Table 3.

TABLE 3

| | Example 12 | Example 13 | Example 14 | Example 15 | Example 16 | Example 17 |
|---|---|---|---|---|---|---|
| Electrode to which composite particles are blended | Positive | Positive | Positive | Positive | Positive | Positive |
| | electrode | electrode | electrode | electrode | electrode | electrode |
| High-dielectric oxide solid particle | LATP | BTO | KNO | BTO | LATP | LATP |
| Electron conducting material constituting | Carbon | CB | CB | Carbon | CB | CB |
| composite particles | | | | | | |
| Electron conducting material:high-dielectric | 3:97 | 1:6 | 1:6 | 3:97 | 1:6 | 1:6 |
| oxide solid particle (mass ratio) | | | | | | |
| Integrating step | Chemical | Mechanical | Mechanical | Chemical | Mechanical | Mechanical |
| Composition of composite particles in | 1.0 | 1.0 | 1.0 | 1.0 | 0.5 | 5.0 |
| electrode mixture (% by mass) | | | | | | |
| Initial discharge capacity (mAh) | 42.5 | 42.7 | 42.3 | 42.4 | 42.0 | 41.8 |
| Discharge capacity after durability test (mAh) | 38.0 | 38.1 | 37.7 | 37.9 | 37.4 | 37.1 |
| Capacity retention rate (%) | 89.5 | 89.1 | 89.1 | 89.4 | 89.0 | 88.8 |
| Initial cell resistance (Ω) | 0.944 | 0.950 | 0.950 | 0.945 | 0.952 | 0.957 |
| Cell resistance after durability test (Ω) | 1.17 | 1.18 | 1.18 | 1.17 | 1.18 | 1.19 |
| Cell resistance increasing rate (%) | 123.7 | 124.2 | 124.2 | 123.8 | 124.3 | 124.7 |

### Example 13

Composite particles were produced in the same manner as in Example 7 except that BTO shown in Table 1 was used as the high-dielectric oxide solid particle and CB as an electron conducting material and BTO as high-dielectric oxide solid particles were mixed with each other at a mass ratio of CB:BTO=1:6.

When the obtained composite particles were observed under an electron microscope, the coverage of a surface of BTO with CB was 36%.

Next, a lithium ion secondary battery was produced in the same manner as in Example 7 except that the composite particles produced in this Example were used, and evaluated in the same manner as in Example 7.

The results are shown in Table 3.

### Example 14

Composite particles were produced in the same manner as in Example 7 except that KNO shown in Table 1 was used as the high-dielectric oxide solid particle, and CB as an electron conducting material and KNO as high-dielectric oxide solid particles were mixed with each other at a mass ratio of CB:KNO=1:6.

When the obtained composite particles were observed under an electron microscope, the coverage of a surface of KNO with CB was 27.

Next, a lithium ion secondary battery was produced in the same manner as in Example 7 except that the composite particles produced in this Example were used, and evaluated in the same manner as in Example 7.

The results are shown in Table 3.

### Example 15

### [Production of Composite Particles]

BTO (median diameter (D50): 0.6 μm) as shown in Table 1 as high-dielectric oxide solid particle, in an amount of 20 g, was inserted into a quartz tube kiln furnace capable of controlling a gas atmosphere. While the quartz tube kiln furnace was rotated at 2 rpm, propane gas was allowed to flow at 300 ml/min; and calcination was carried out at 800° C. for 120 minutes, thereby carbonizing propane gas by thermal decomposition, and coating a surface of BTO with the produced carbon to obtain composite particles.

When the obtained composite particles were visually observed and observed under an electron microscope, the coverage of a surface of BTO with carbon was 100%.

Furthermore, a thickness of the carbon covering the surface of BTO was 19 mm.

Next, a lithium ion secondary battery was produced in the same manner as in Example 7 except that the composite particles produced in this Example were used, and evaluated in the same manner as in Example 7.

The results are shown in Table 3.

### Example 16

A lithium ion secondary battery was produced in the same manner as in Example 7 except that the composite particles produced in Example 8 were used and the mass ratio of each component in the positive electrode paste was NCM622:CB:LATP:PVDF=93.6:4.1:0.5:1.8, and evaluated in the same manner as in Example 7.

The results are shown in Table 3.

### Example 17

A lithium ion secondary battery was produced in the same manner as in Example 7 except that the composite particles produced in Example 8 were used and the mass ratio of each component in the positive electrode paste was NCM622:CB:LATP:PVDF=89.1:4.1:5.0:1.8, and evaluated in the same manner as in Example 7.

The results are shown in Table 3.

### Example 18

### [Production of Composite Particles]

LLZO (median diameter (D50): 0.7 μm) as shown in Table 1 as the high-dielectric oxide solid particle, in an amount of 20 g, was inserted into a quartz tube kiln furnace capable of controlling a gas atmosphere. While the quartz tube kiln furnace was rotated at 2 rpm, propane gas was allowed to flow at 300 ml/min, and calcination was carried out at 800° C. for 20 minutes, thereby carbonizing propane gas by thermal decomposition, and coating the LLZO surface with the produced carbon to obtain composite particles.

When the obtained composite particles were observed under an electron microscope, the coverage of a surface of LLZO with carbon was 100%. Furthermore, a thickness of the carbon covering the surface of LLZO was 19 mm.

[Production of Positive Electrode]

Carbon black (CB) as the electron conducting material, and polyvinylidene fluoride (PVDF) as a binding agent (binder), and N-methyl-2-pyrrolidone (NMP) as a dispersion solvent were wet-mixed with each other by a rotation-revolution mixer to obtain a preliminarily mixed slurry.

Subsequently, NCM622 as the positive electrode active material and the obtained preliminarily mixed slurry were mixed with each other, and subjected to dispersion treatment using a planetary mixer to obtain a positive electrode paste.

The mass ratio of each component in the positive electrode paste was set to be NCM622:CB:PVDF=94.0:4.1:1.9.

NCM622 has a median diameter of 12 μm.

Furthermore, carbon black (B) is the same as that used for the composite particles.

Next, the obtained positive electrode paste was applied to a positive electrode current collector made of aluminum, dried, pressurized by roll press, and then dried at 120° C. in vacuum to form a positive electrode plate having a positive electrode mixture layer.

The obtained positive electrode plate was punched into a size of 30 mm×40 mm to obtain a positive electrode.

[Production of Negative Electrode]

The composite particles obtained above and a carboxymethyl cellulose (CMC) aqueous solution as a binding agent (binder) were preliminarily mixed using a planetary mixer.

Subsequently, natural graphite (NG) as a negative electrode active material was mixed therein, and further preliminarily mixed using a planetary mixer.

Thereafter, water as a dispersion solvent and styrene-butadiene rubber (SBR) as a binding agent (binder) were added thereto, and the obtained product was subjected to dispersion treatment using a planetary mixer to obtain a negative electrode paste.

The mass ratio of each component in the negative electrode paste was set to be NG:CB:LLZO:SBR:CMC=96.0:1.0:0.5:1.5:1.0.

The natural graphite has a median diameter of 12 μm.

Next, the obtained negative electrode paste was applied to a negative electrode current collector made of copper, dried, pressurized by roll press, and then dried at 100° C. in vacuum to form a negative electrode plate having a negative electrode mixture layer.

The obtained negative electrode plate was punched into a size of 34 mm×44 mm to obtain a negative electrode.

[Production of Lithium Ion Secondary Battery]

A lithium ion secondary battery was produced in the same manner as in Example 7 except that the positive electrode and the negative electrode obtained in this Example were used, and evaluated in the same manner as in Example 7.

The results are shown in Table 4.

TABLE 4

| | Example 18 | Example 19 | Example 20 | Example 21 | Example 22 | Example 23 |
|---|---|---|---|---|---|---|
| Electrode to which composite particles are blended | Negative | Negative | Negative | Negative | Negative | Negative |
| | electrode | electrode | electrode | electrode | electrode | electrode |
| High-dielectric oxide solid particle | LLZO | LPO | LNO | BTO | KNO | LLZO |
| Electron conducting material constituting | Carbon | CB | CB | Carbon | CB | CB |
| composite particles | | | | | | |
| Electron conducting material:high-dielectric | 3:97 | 1:6 | 1:6 | 3:97 | 1:6 | 1:6 |
| oxide solid particle (mass ratio) | | | | | | |
| Integrating step | Chemical | Mechanical | Mechanical | Chemical | Mechanical | Mechanical |
| Composition of composite particles in | 0.5 | 0.5 | 0.5 | 0.5 | 0.5 | 0.1 |
| electrode mixture (% by mass) | | | | | | |
| Initial discharge capacity (mAh) | 42.5 | 42.7 | 42.3 | 42.4 | 42.0 | 41.8 |
| Discharge capacity after durability test (mAh) | 38.0 | 38.1 | 37.8 | 37.9 | 37.5 | 37.3 |
| Capacity retention rate (%) | 89.5 | 89.3 | 89.3 | 89.5 | 89.4 | 89.3 |
| Initial cell resistance (Ω) | 0.943 | 0.948 | 0.946 | 0.943 | 0.945 | 0.947 |
| Cell resistance after durability test (Ω) | 1.17 | 1.17 | 1.17 | 1.17 | 1.17 | 1.17 |
| Cell resistance increasing rate (%) | 123.7 | 124.0 | 123.9 | 123.7 | 123.8 | 123.9 |

### Example 19

A lithium ion secondary battery was produced in the same manner as in Example 18 except that the composite particles produced in Example 9 were used, and evaluated in the same manner as in Example 7.

The results are shown in Table 4.

### Example 20

A lithium ion secondary battery was produced in the same manner as in Example 18 except that the composite particles produced in Example 10 were used, and evaluated in the same manner as in Example 7.

The results are shown in Table 4.

### Example 21

A lithium ion secondary battery was produced in the same manner as in Example 18 except that the composite particles produced in Example 15 were used, and evaluated in the same manner as in Example 7.

The results are shown in Table 4.

### Example 22

A lithium ion secondary battery was produced in the same manner as in Example 18 except that the composite particles produced in Example 14 were used, and evaluated in the same manner as in Example 7.

The results are shown in Table 4.

### Example 23

Composite particles were produced in the same manner as in Example 7 except that LLZO shown in Table 1 was used as high-dielectric oxide solid particles, and CB as the electron conducting material and LLZO as the high-dielectric oxide solid particles were mixed with each other at a mass ratio of CB:LLZO=1:6.

When the obtained composite particles were observed under an electron microscope, the coverage of a surface of IZO with CB was 15%.

Next, a lithium ion secondary battery was produced in the same manner as in Example 18 except that composite particles produced in this Example were used and the mass ratio of each component in the negative electrode paste was NG:CB:LLZO:SBR:CMC=96.4:1.0:0.1:1.5:1.0, and evaluated in the same manner as in Example 7.

The results are shown in Table 4.

### Example 24

### [Production of Composite Particles]

### (Production of Composite Particles-1)

Composite particles were produced in the same manner as in Example 7 except that CB as the electron conducting material and LATP as the high-dielectric oxide solid particles were mixed with each other at a mass ratio of CB:LATP=1:4.

When the obtained composite particles were observed under an electron microscope, the coverage of a surface of LATP with CB was 26%.

### (Production of Composite Particles-2)

Composite particles were produced in the same manner as in Example 7 except that CB as the electron conducting material and LLZO as the high-dielectric oxide solid particles were mixed with each other at a mass ratio of CB:LLZO=1:4.

When the obtained composite particles were observed under an electron microscope, the coverage of a surface of LLZO with CB was 46%.

[Production of Positive Electrode]

A positive electrode was produced in the same manner as in Example 7 except that the composite particles-1 produced above were used.

[Production of Negative Electrode]

A positive electrode was produced in the same manner as in Example 19 except that the composite particles-2 produced above were used.

A lithium ion secondary battery was produced in the same manner as in Example 7 except that the positive electrode and the negative electrode produced in this Example were used, and evaluated in the same manner as in Example 7.

The results are shown in Table 5.

TABLE 5

| | | Example 24 | Example 25 | Example 26 | Example 27 |
|---|---|---|---|---|---|
| Electrode to which composite particles are blended | | Both | Both | Both | Both |
| | | electrodes | electrodes | electrodes | electrodes |
| Positive | High-dielectric oxide solid particle | LATP | LATP | BTO | LATP |
| electrode | Electron conducting material constituting | CB | CB | Carbon | Carbon |
| | composite particles | | | | |
| | Electron conducting material:high-dielectric | 1:4 | 1:4 | 3:97 | 3:97 |
| | oxide solid particle (mass ratio) | | | | |
| | Integrating step | Mechanical | Mechanical | Chemical | Chemical |
| | Composition of composite particles in | 1.0 | 1.0 | 1.0 | 0.5 |
| | electrode mixture (% by mass) | | | | |
| Negative | High-dielectric oxide solid particle | LLZO | BTO | LLZO | BTO |
| electrode | Electron conducting material constituting | CB | Carbon | Carbon | — |
| | composite particles | | | | |
| | Electron conducting material:high-dielectric | 1:4 | 3:97 | 3:97 | — |
| | oxide solid particle (mass ratio) | | | | |
| | Integrating step | Mechanical | Chemical | Chemical | — |
| | Composition of composite particles in | 0.5 | 0.5 | 0.5 | 0.5 |
| | electrode mixture (% by mass) | | | | |

| | | | | |
|---|---|---|---|---|
| Initial discharge capacity (mAh) | 42.5 | 42.7 | 42.3 | 42.4 |
| Discharge capacity after durability test (mAh) | 37.8 | 38.2 | 37.9 | 37.9 |
| Capacity retention rate (%) | 89.0 | 89.5 | 89.6 | 89.5 |
| Initial cell resistance (Ω) | 0.952 | 0.943 | 0.940 | 0.943 |
| Cell resistance after durability test (Ω) | 1.18 | 1.17 | 1.16 | 1.17 |
| Cell resistance increasing rate (%) | 124.3 | 123.7 | 123.5 | 123.7 |

### Example 26

A lithium ion secondary battery was produced in the same manner as in Example 7 except that the positive electrode produced in Example 24 and the negative electrode produced in Example 21 were used, and evaluated in the same manner as in Example 7.

The results are shown in Table 5.

### Example 26

A lithium ion secondary battery was produced in the same manner as in Example 7 except that the positive electrode produced in Example 15 and the negative electrode produced in Example 18 were used, and evaluated in the same manner as in Example 7.

The results are shown in Table 5.

### Example 27

### [Production of Positive Electrode]

A positive electrode was produced in the same manner as in Example 7 except that composite particles produced in Example 12 were used and the mass ratio of components in the positive electrode paste was NCM622:CB:LATP:PVDF=93.6:4.1:0.5:1.8, and the lithium ion secondary battery was evaluated as in Example 7.

[Production of Negative Electrode]

CB as the electron conducting material, BTO as the high-dielectric oxide solid particle, and a carboxymethyl cellulose (CMC) aqueous solution as a binding agent (binder) were preliminarily mixed with each other using a planetary mixer.

Subsequently, natural graphite (NG) as a negative electrode active material was mixed therein, and further preliminarily mixed using a planetary mixer.

Thereafter, water as a dispersion solvent and styrene-butadiene rubber (SBR) as a binding agent (binder) were added thereto, and the obtained product was subjected to dispersion treatment using a planetary mixer to obtain a negative electrode paste.

The mass ratio of each component in the negative electrode paste was set to be NG:CB:BTO:SBR:CMC=96.0:1.0:0.5:1.5:1.0.

Next, the obtained negative electrode paste was applied to a negative electrode current collector made of copper, dried, pressurized by roll press, and then dried at 100° C. in vacuum to form a negative electrode plate having a negative electrode mixture layer.

The obtained negative electrode plate was punched into a size of 34 mm×44 mm to obtain a negative electrode.

In the positive electrode paste produced in this Example, the carbon black and BTO are simply mixed with each other, and composite particles are not formed.

[Production of Lithium Ion Secondary Battery]

A lithium ion secondary battery was produced in the same manner as in Example 7 except that the positive electrode and the negative electrode produced above were used, and evaluated in the same manner as in Example 7.

The results are shown in Table 5.

### Comparative Example 3

A lithium ion secondary battery was produced in the same manner as in Example 7 except that the positive electrode produced in Example 18 and the negative electrode produced in Example 7 were used, and evaluated in the same manner as in Example 7.

In other words, in this Comparative Example, both the positive electrode and the negative electrode includes neither composite particles nor the high-dielectric oxide solid particle at all.

The results are shown in Table 6.

TABLE 6

| | | Comparative | Comparative | Comparative | Comparative | Comparative |
|---|---|---|---|---|---|---|
| | | Example 3 | Example 4 | Example 5 | Example 6 | Example 7 |
| Electrode to which inorganic particles are blended | | — | Positive | Negative | Negative | Positive |
| | | | electrode | electrode | electrode | electrode |
| Positive | High-dielectric oxide solid particle | — | LATP | — | — | AlO |
| electode | Electron conducting material constituting | — | — | — | — | — |
| | composite particles | | | | | |
| | Electron conducting material:high-dielectric | — | — | — | — | — |
| | oxide solid particle (mass ratio) | | | | | |
| | Integrating step | — | — | — | — | — |
| | Composition of composite particles in | — | 1.0 | — | — | 1.0 |
| | electrode mixture (% by mass) | | | | | |
| Negative | High-dielectric oxide solid particle | — | — | LLZO | LATP | — |
| electrode | Electron conducting material constituting | — | — | — | — | — |
| | composite particles | | | | | |
| | Electron conducting material:high-dielectric | — | — | — | — | — |
| | oxide solid particle (mass ratio) | | | | | |
| | Integrating step | — | — | — | — | — |
| | Composition of composite particles in | — | — | 0.5 | 0.5 | — |
| | electrode mixture (% by mass) | | | | | |

| | | | | | |
|---|---|---|---|---|---|
| Initial discharge capacity (mAh) | 42.5 | 41.8 | 42.1 | 41.2 | 42.0 |
| Discharge capacity after durability test (mAh) | 37.1 | 35.9 | 36.5 | 35.8 | 37.0 |
| Capacity retention rate (%) | 87.2 | 86.0 | 86.8 | 87.0 | 88.0 |
| Initial cell resistance (Ω) | 1.000 | 0.985 | 0.964 | 1.025 | 1.210 |
| Cell resistance after durability test (Ω) | 1.43 | 1.28 | 1.28 | 1.39 | 1.63 |
| Cell resistance increasing rate (%) | 142.6 | 129.8 | 133.0 | 135.6 | 135.0 |

### Comparative Example 4

### [Protection of Positive Electrode]

CB as the electron conducting material, LATP as the high-dielectric oxide solid particle, and polyvinylidene fluoride (PVDF) as a binding agent (binder) were preliminarily mixed with each other, and wet-mixed in a N-methyl-2-pyrrolidone (NMP) as a dispersion solvent by a rotation-revolution mixer to obtain a preliminarily mixed slurry. Subsequently, NCM622 as the positive electrode active material and the obtained preliminarily mixed slurry were mixed with each other, and subjected to dispersion treatment using a planetary mixer to obtain a positive electrode paste.

The mass ratio of each component in the positive electrode paste was set to be NCM622:CB:LATP:PVDF=93.1:4.1:1.0:1.8.

Next, the obtained positive electrode paste was applied to a positive electrode current collector made of aluminum, dried, pressurized by roll press, and then dried at 120° C. in vacuum to form a positive electrode plate having a positive electrode mixture layer.

The obtained positive electrode plate was punched into a size of 30 mm×40 mm to obtain a positive electrode.

In the positive electrode paste produced in this Comparative Example, the carbon black and BTO are simply mixed with each other, and composite particles are not formed.

A lithium ion secondary battery was produced in the same manner as in Example 7 except that the positive electrode produced above and the negative electrode produced in Example 7 were used, and evaluated in the same manner as in Example 7.

The results are shown in Table 6.

### Comparative Example 5

### [Production of Negative Electrode]

CB as the electron conducting material, LLZO as the high-dielectric oxide solid particle, and carboxymethyl cellulose (CMC) aqueous solution as a binding agent (binder) were preliminarily mixed with each other using a planetary mixer.

Subsequently, natural graphite (NG) as a negative electrode active material was mixed therein, and further preliminarily mixed using a planetary mixer.

Thereafter, water as a dispersion solvent and styrene-butadiene rubber (SBR) as a binding agent (binder) were added thereto, and the obtained product was subjected to dispersion treatment using a planetary mixer to obtain a negative electrode paste.

The mass ratio of each component in the negative electrode paste was set to be NG:CB:LLZO:SBR:CMC=96.0:1.0:0.5:1.5:1.0.

Next, the obtained negative electrode paste was applied to a negative electrode current collector made of copper, dried, pressurized by roll press, and then dried at 100° C. in vacuum to form a negative electrode plate having a negative electrode mixture layer.

The obtained negative electrode plate was punched into a size of 34 mm×44 mm to obtain a negative electrode.

In the negative electrode paste produced in this Example, the carbon black and LLZO are simply mixed with each other, and composite particles are not formed.

[Production of Lithium Ion Secondary Battery]

A lithium ion secondary battery was produced in the same manner as in Example 7 except that the positive electrode produced in Example 18 and the negative electrode produced above were used, and evaluated in the same manner as in Example 7.

The results are shown in Table 6.

### Comparative Example 6

### [Production of Negative Electrode]

CB as the electron conducting material, LATP as the high-dielectric oxide solid particle, and carboxymethyl cellulose (CMC) aqueous solution as a binding agent (binder) were preliminarily mixed using a planetary mixer.

Subsequently, natural graphite (NG) as a negative electrode active material was mixed therein, and further preliminarily mixed using a planetary mixer.

Thereafter, water as a dispersion solvent and styrene-butadiene rubber (SBR) as a binding agent (binder) were added thereto, and the obtained product was subjected to dispersion treatment using a planetary mixer to obtain a negative electrode paste.

The mass ratio of each component in the negative electrode paste was set to be NG:CB:LATP:SBR:CMC=96.0:1.0:0.5:1.5:1.0.

Next, the obtained negative electrode paste was applied to a negative electrode current collector made of copper, dried, pressurized by roll press, and then dried at 100° C. in vacuum to form a negative electrode plate having a negative electrode mixture layer.

The obtained negative electrode plate was punched into a size of 34 mm×44 mm to obtain a negative electrode.

In the positive electrode paste produced in this Example, the carbon black and LATP are simply mixed with each other, and composite particles are not formed.

[Production of Lithium Ion Secondary Battery]

A lithium ion secondary battery was produced in the same manner as in Example 7 except that the positive electrode produced in Example 18 and the negative electrode produced above were used, and evaluated in the same manner as in Example 7.

The results are shown in Table 6.

### Comparative Example 7

### [Production of Positive Electrode]

CB as the electron conducting material, AlO shown in Table 1 as the high-dielectric oxide solid particle, and polyvinylidene fluoride (PVDF) as a binding agent (binder) were preliminarily mixed with each other, and wet-mixed in a N-methyl-2-pyrrolidone (NMP) as a dispersion solvent by a rotation-revolution mixer to obtain a preliminarily mixed slurry.

Subsequently, NCM622 as the positive electrode active material and the obtained preliminarily mixed slurry were mixed with each other, and subjected to dispersion treatment using a planetary mixer to obtain a positive electrode paste.

The mass ratio of each component in the positive electrode paste was set to be NCM622:CB:AlO:PVDF=93.1:4.1:1.0:1.8.

Next, the obtained positive electrode paste was applied to a positive electrode current collector made of aluminum, dried, pressurized by roll press, and then dried at 120° C. in vacuum to form a positive electrode plate having a positive electrode mixture layer.

The obtained positive electrode plate was punched into a size of 30 mm×40 mm to obtain a positive electrode.

In the positive electrode paste produced in this Comparative Example, the carbon black and AlO are simply mixed with each other, and composite particles are not formed.

A lithium ion secondary battery was produced in the same manner as in Example 7 except that the positive electrode produced above and the negative electrode produced in Example 7 were used, and evaluated in the same manner as in Example 7.

The results are shown in Table 6.

1. Composite particles being particles to be blended in an electrode of a lithium ion secondary battery including an electrolyte solution, the composite particles comprising high-dielectric oxide solid particles and an electron conducting material, at least a portion of a surface of the high-dielectric oxide solid particles being covered with the electron conducting material.

2. The composite particles according to claim 1, wherein the electron conducting material is supported by and integrated with a surface of the high-dielectric oxide solid particles.

3. The composite particles according to claim 1, wherein the electron conducting material has pores, and stores an electrolyte solution in the pores.

4. The composite particles according to claim 1, wherein the electron conducting material is a conductive carbon.

5. The composite particles according to claim 1, wherein the electron conducting material has an electronic conductivity of 10⁻¹ S/cm or more at 25° C., and a DBP oil absorption amount of 100 ml/00 g or more.

6. The composite particles according to claim 1, wherein the high-dielectric oxide solid particles are an oxide solid having a relative dielectric constant of powder at 25° C. of 10 or more.

7. The composite particles according to claim 1, wherein the high-dielectric oxide solid particles are an oxide solid having a lithium ion conductivity at 25° C. of 10⁻⁷ S/cm or more.

8. The composite particles according to claim 1, wherein the electrode is a positive electrode, and the high-dielectric oxide solid particles are not dissolved in the electrolyte solution, and does not show pH of 12 or more at a time when the high-dielectric oxide solid particles are impregnated with an aqueous solution.

9. The composite particles according to claim 1, wherein the electrode is a negative electrode, and
the high-dielectric oxide solid particles are not dissolved in the electrolyte solution, and are not reductively decomposed at 1 V or more with respect to a Li/Li⁺ electrode.

10. The composite particles according to claim 1, wherein a coverage rate of the electron conducting material on a surface of the high-dielectric oxide solid particles is 15% or more.

11. The composite particles according to claim 1, wherein a mass ratio of the electron conducting material to the high-dielectric oxide solid particles is 0.5:99.5 to 80:20.

12. A method for producing the composite particles according to claim 1, the method comprising:
an integrating step of attaching or bonding the electron conducting material to a surface of the high-dielectric oxide solid particles by a mechanical technique or a chemical technique.

13. An electrode for a lithium ion secondary battery comprising an electrolyte solution, comprising a layer made of an electrode mixture including an electrode active material, and the composite particles according to claim 1.

14. The electrode for a lithium ion secondary battery according to claim 13, wherein a blending amount of the composite particles is 0.1 parts by mass or more and 5 parts by mass or less with respect to a total of the electrode mixture.

15. The electrode for a lithium ion secondary battery according to claim 13, wherein the composite particles have an average particle diameter of 1/10 or less of an average particle diameter of the electrode active material, and the high-dielectric oxide solid particles have an average particle diameter of 5 times or more as large as an average particle diameter of primary particles of the electron conducting material.

16. The electrode for a lithium ion secondary battery according to claim 13, wherein the composite particles have an average particle diameter of 1/10 or less of an average particle diameter of the electrode active material, and the high-dielectric oxide solid particles have an average particle diameter of 5 times or more as large as a thickness of the electron conducting material.

17. The electrode for a lithium ion secondary battery according to claim 13, wherein a mass ratio of the electrode active material to the composite particles is 99.5:0.5 to 80:20.

18. The electrode for a lithium ion secondary battery according to claim 13, wherein the electrode for a lithium ion secondary battery is a positive electrode.

19. The electrode for a lithium ion secondary battery according to claim 13, wherein the electrode for a lithium ion secondary battery is a negative electrode.

20. A lithium ion secondary battery comprising a positive electrode, a negative electrode, and an electrolyte solution, at least one of the positive electrode and the negative electrode being the electrode for a lithium ion secondary battery according to claim 13.
